(19) United States
(12) Patent Application Publication
(10) Pub. No.: US 2012/0113379 A1
(43) Pub. Date: May 10, 2012

(54) METHOD FOR MANUFACTURING LIQUID CRYSTAL DISPLAY DEVICE

(75) Inventors: Kazunari Tomizawa, Osaka-shi (JP); Yuichi Yoshida, Osaka-shi (JP); Tomohiko Mori, Osaka-shi (JP)

(73) Assignee: SHARP KABUSHIKI KAISHA, Osaka-shi, Osaka (JP)

(21) Appl. No.: 13/384,439

(22) PCT Filed: Jul. 20, 2010
(86) PCT No.: PCT/JP2010/062174

§ 371 Date: Jan. 17, 2012

(30) Foreign Application Priority Data
Jul. 22, 2009 (JP) 2009-171517
Nov. 18, 2009 (JP) 2009-262749

(51) Int. Cl. G02F 1/1333

(52) U.S. Cl. 349/187

(57) ABSTRACT

A liquid crystal display device (100) according to the present invention comprises the steps of: providing a liquid crystal display panel (200), which includes an active-matrix substrate, a counter substrate, and a vertical alignment liquid crystal layer interposed between the active-matrix substrate and the counter substrate; if an achromatic color should be represented, obtaining the chromaticity of the liquid crystal display panel (200) when viewed straight on with respect to each grayscale level and determining a range in which the chromaticity of the liquid crystal display panel (200) when viewed obliquely is adjustable by changing the luminances of respective blue subpixels belonging to the two pixels within their adjustable range; and setting the luminances of the blue subpixels so that the chromaticity of the liquid crystal display panel when viewed obliquely becomes as close to the chromaticity of the liquid crystal display panel when viewed straight on as possible within the adjustable range with respect to at least a part of the entire range of the grayscale levels.

### TECHNICAL FIELD

The present invention relates to a method for fabricating a liquid crystal display device.

### BACKGROUND ART

Liquid crystal displays (LCDs) have been used in not only small display devices such as the monitor screen of a cellphone but also TV sets with a big screen. TN (twisted nematic) mode LCDs, which would often be used in the past, achieved relatively narrow viewing angles, but LCDs of various other modes with wider viewing angles have recently been developed one after another. Examples of those wider viewing angle modes include IPS (in-plane switching) mode and VA (vertical alignment) mode. Among those wide viewing angle modes, the VA mode is adopted in a lot of LCDs because the VA mode would achieve a sufficiently high contrast ratio.

When viewed obliquely, however, the VA mode LCD sometimes produces grayscale inversion. Thus, to minimize such grayscale inversion, an MVA (multi-domain vertical alignment) mode LCD in which multiple liquid crystal domains are defined within a single pixel region is adopted. In an MVA mode LCD, an alignment control structure is provided for at least one of the two substrates, which face each other with a vertical alignment liquid crystal layer interposed between them, so that the alignment control structure contacts with the liquid crystal layer. As the alignment control structure, a linear slit (opening) of an electrode or a rib (projection) may be used, thereby applying alignment control force to the liquid crystal layer from one or both sides thereof. In this manner, multiple (typically four) liquid crystal domains with multiple different alignment directions are defined, thereby minimizing the grayscale inversion.

Also known as another kind of VA mode LCD is a CPA (continuous pinwheel alignment) mode LCD. In a normal CPA mode LCD, its pixel electrodes have a highly symmetric shape and either an opening or a projection (which is sometimes called a “rivet”) is arranged on the surface of the counter substrate in contact with the liquid crystal layer so as to be aligned with the center of a liquid crystal domain. When a voltage is applied, an oblique electric field is generated by the counter electrode and the highly symmetric pixel electrode and induces radially tilted alignments of liquid crystal molecules. Also, with a rivet provided, the alignment control force produced on the slope of the rivet stabilizes the tilted alignments of the liquid crystal molecules. As the liquid crystal molecules are radially aligned within a single pixel in this manner, the grayscale inversion can be minimized.

However, a viewing angle characteristic problem in a different phase has arisen just recently. Specifically, the γ characteristic of LCDs would vary with the viewing angle. That is to say, the γ characteristic when the screen is viewed straight on is different from the characteristic when it is viewed obliquely. As used herein, the “γ characteristic” refers to the grayscale dependence of display luminance. That is why if the γ characteristic when viewed straight on is different from the characteristic when viewed obliquely, then it means that the grayscale display state changes according to the viewing direction. This is a serious problem particularly when a still picture such as a photo is presented or when a TV program is displayed.

Such a viewing angle dependence of the γ characteristic in the vertical alignment mode is noticeable as a so-called “whitening” phenomenon that the display luminance as viewed obliquely becomes higher than the intended one. Once such whitening has occurred, the color displayed on the screen by pixels when viewed obliquely will be different from the color displayed there by the same pixels when viewed straight on, which is also a problem.

As a technique for reducing the viewing angle dependence of the γ characteristic, a so-called “multi-pixel driving” method is proposed in Patent Documents Nos. 1 and 2, for example. According to that technique, a single subpixel is split into two regions and mutually different voltages are applied to those regions, thereby reducing the viewing angle dependence of the γ characteristic.

Also, a normal liquid crystal display device represents colors usually by adding together the three primary colors of red (R), green (G) and blue (b). Thus, each pixel in a color display panel has red, green and blue subpixels for these three primary colors of RGB. Such a display device is sometimes called a “three-primary-color display device”. YCrCb (YCC) signals, which can be converted into RGB signals, are input to the display panel of such a three-primary-color display device and the red, green and blue subpixels change their luminances in response to the YCrCb signals, thereby representing various colors. In the following description, a subpixel's luminance level corresponding to the lowest grayscale level (e.g., grayscale level 0) will be represented herein as “0” and a subpixel's luminance level corresponding to the highest grayscale level (e.g., grayscale level 255) will be represented herein as “1” for convenience sake. The luminances of the red, green and blue subpixels are controlled within the range of “0” through “1”.

If the luminances of all of these subpixels, namely, the red, green and blue subpixels, is “0”, the color represented by the pixel is black. Conversely, if the luminances of all of these subpixels is “1”, the color represented by the pixel is white. Recently, TV sets are more and more often designed to allow the user to control the color temperature. In that case, the color temperature is controlled by finely adjusting the luminances of the respective subpixels. In this description, the luminances of the subpixels after the color temperature has been adjusted into a desired one are supposed to be one.

Hereinafter, it will be described how the luminances of respective subpixels vary in a normal three-primary-color display device in a situation where the color displayed by pixels changes from black into white while being an achromatic color. In the beginning, the color displayed by pixels is black and the luminances of red, green and blue subpixels are “0”. But the red, green and blue subpixels soon start to increase their luminances. In this case, the luminances of the red, green and blue subpixels increase at the same rate. And the higher the luminances of the red, green and blue subpixels, the higher the lightness of the color displayed by the pixels. And when the increasing luminances of the red, green and blue subpixels reaches “1”, the color displayed by the pixels will become white. By varying the luminances of the red, green and blue subpixels at the same rate in this manner, the lightness of the achromatic color can be changed.

Strictly speaking, however, if the lightness of an achromatic color is changed, the color displayed by pixels sometimes changes (see Patent Document No. 3, for example). Patent Document No. 3 discloses that if the lightness of an achromatic color is changed, a gamma correction should be carried out so that the value of a blue subpixel becomes higher than those of red and green subpixels. In the liquid crystal display device disclosed in Patent Document No. 3, an sRGB color space is converted into the color space of an LCD panel through a PCS (profile connection space) and then a gamma correction process is carried out using a gamma curve in which the value of a blue subpixel is higher than those of red and green subpixels at a middle grayscale. As a result, the variation in achromatic color with the variation in lightness can be reduced. Such a process is also called an “independent gamma correction process”.

### CITATION LIST

### Patent Literature

Patent Document No. 1: Japanese Patent Application Laid-Open Publication No. 2004-62146
Patent Document No. 2: Japanese Patent Application Laid-Open Publication No. 2004-78157
Patent Document No. 3: Japanese Patent Application Laid-Open Publication No. 2001-312254

### SUMMARY OF INVENTION

### Technical Problem

The present inventors discovered that even if an appropriate achromatic color is being displayed on a VA mode liquid crystal display device when viewed straight on, sometimes the achromatic color may appear to have a tint of another color when viewed obliquely and the display quality may deteriorate.

It is therefore an object of the present invention to provide a method for fabricating a liquid crystal display device that can minimize such deterioration in display quality that could be caused when the screen is viewed obliquely.

### Solution to Problem

A method for fabricating a liquid crystal display device according to the present invention includes the steps of: providing a liquid crystal display panel, which includes an active-matrix substrate, a counter substrate, and a vertical alignment liquid crystal layer that is interposed between the active-matrix substrate and the counter substrate and which has a number of pixels, each of the pixels including multiple subpixels that include red, green and blue subpixels, each of the subpixels having multiple regions, of which the luminances are able to be different from each other; if an input signal indicates that two adjacent ones of the pixels should represent an achromatic color with the same grayscale level, obtaining the chromaticity of the liquid crystal display panel when viewed straight on with respect to each said grayscale level and determining a range in which the chromaticity of the liquid crystal display panel when viewed obliquely is adjustable by changing the luminances of respective blue subpixels belonging to the two pixels within their adjustable range; and setting the luminances of the blue subpixels so that the chromaticity of the liquid crystal display panel when viewed obliquely becomes as close to the chromaticity of the liquid crystal display panel when viewed straight on as possible within the adjustable range with respect to at least a part of the entire range of the grayscale levels.

In one preferred embodiment, in the step of setting the luminances of the blue subpixels, the liquid crystal display panel has a lower chromaticity when viewed straight on than when viewed obliquely with respect to each said grayscale level.

In this particular preferred embodiment, in the step of setting the luminances of the blue subpixels, if a lowest chromaticity curve, which is plotted by connecting together, over the entire range of the grayscale levels, the respective lowest chromaticities in the adjustable ranges that are associated with the respective grayscale levels, has multiple inflection points, the chromaticity of the liquid crystal display panel when viewed obliquely is different from the lowest chromaticity within the adjustable range at grayscale levels between two adjacent ones of the multiple inflection points.

In a specific preferred embodiment, the step of setting the luminances of the blue subpixels includes setting the luminances of the blue subpixels so that the chromaticity of the liquid crystal display panel when viewed obliquely changes substantially linearly between the two inflection points.

In a more specific preferred embodiment, in the step of setting the luminances of the blue subpixels, if the grayscale level is between the two inflection points, the luminance of the blue subpixel that is included in one of the two pixels of the liquid crystal display panel is set to be different from the luminance of the blue subpixel that is included in the other pixel. And if the chromaticity of the liquid crystal display panel when viewed obliquely is the lowest one within the adjustable range, the luminance of the blue subpixel that is included in one of the two pixels of the liquid crystal display panel is set to be substantially equal to the luminance of the blue subpixel that is included in the other pixel.

In another preferred embodiment, in the step of setting the luminances of the blue subpixels, if the grayscale level is located at some point between the two inflection points, the luminance of the blue subpixel that is included in one of the two pixels of the liquid crystal display panel is set to be substantially equal to the luminance of the blue subpixel that is included in the other pixel. And if the grayscale level is located at another point between the two inflection points, the luminance of the blue subpixel that is included in one of the two pixels of the liquid crystal display panel is set to be different from the luminance of the blue subpixel that is included in the other pixel.

### Advantageous Effects of Invention

According to the present invention, a liquid crystal display device that can minimize deterioration in display quality, which could be caused when the screen is viewed obliquely, can be fabricated.

### BRIEF DESCRIPTION OF DRAWINGS

FIG. 1 is a schematic representation illustrating a liquid crystal display device as a preferred embodiment of the present invention.

FIG. 2(a) is a schematic representation illustrating the LCD panel of the liquid crystal display device shown in FIG. 1 and FIG. 2(b) is a chromaticity diagram representing the color reproduction range of the LCD panel.

FIG. 3(a) is a schematic representation illustrating how respective pixels may be arranged in the liquid crystal display device shown in FIG. 1, and FIG. 3(b) is a schematic representation illustrating the configuration of a blue subpixel in the LCD panel.

FIG. 4 is a schematic representation illustrating how blue subpixels belonging to respective pixels change their luminances in the liquid crystal display device shown in FIG. 1.

FIG. 5(a) is a schematic representation illustrating how to measure the chromaticity when the LCD panel of the liquid crystal display device shown in FIG. 1 is viewed straight on, and FIG. 5(b) is a schematic representation illustrating how to measure the chromaticity when the LCD panel is viewed obliquely.

FIG. 6 is a graph showing the chromaticity when the LCD panel of the liquid crystal display device shown in FIG. 1 is viewed straight on and the chromaticity adjustable range when the LCD panel is viewed obliquely.

FIG. 7 is a graph showing the colorimetric values when the LCD panel of the liquid crystal display device shown in FIG. 1 is viewed straight on and when the LCD panel is viewed obliquely.

FIG. 8 is a graph showing how the chromaticity varies when the LCD panel of the liquid crystal display device shown in FIG. 1 is viewed straight on and when the LCD panel is viewed obliquely.

FIG. 9 is a graph showing how the output grayscale level changes during the manufacturing process of the liquid crystal display device shown in FIG. 1.

FIG. 10 is a graph showing how the chromaticity y adjustable range as viewed obliquely changes during the manufacturing process of the liquid crystal display device shown in FIG. 1.

FIG. 11 is a graph showing how the chromaticity y as viewed obliquely changes in the liquid crystal display device shown in FIG. 1.

FIG. 12 is a graph showing how the chromaticity x as viewed obliquely changes in the liquid crystal display device shown in FIG. 1.

FIG. 13 is a schematic representation illustrating a configuration for the correcting section of the liquid crystal display device shown in FIG. 1.

FIG. 14 is a graph showing how the chromaticity y as viewed obliquely changes on the LCD panel of the liquid crystal display device shown in FIG. 1.

FIG. 15 is a graph showing how the chromaticities x and y as viewed obliquely change on the LCD panel of the liquid crystal display device shown in FIG. 1.

FIG. 16 is a graph showing how the chromaticity y as viewed obliquely changes on the LCD panel of the liquid crystal display device shown in FIG. 1.

FIG. 17 is a graph showing how the chromaticities x and y as viewed obliquely change on the LCD panel of the liquid crystal display device shown in FIG. 1.

FIG. 18 is a schematic representation showing how the luminance level changes in a situation where blue subpixels belonging to adjacent pixels have mutually different grayscale levels in the liquid crystal display device shown in FIG. 1.

FIGS. 19(a) and 19(c) are schematic representations illustrating a situation where the luminances of blue subpixels are not adjusted on the LCD panel, and FIGS. 19(b) and 19(d) are schematic representations illustrating a situation where the luminances of blue subpixels are adjusted on the LCD panel.

FIG. 20 is a schematic representation illustrating a configuration for the correcting section of a modified example of the liquid crystal display device of this preferred embodiment.

FIGS. 21(a), 21(b) and 21(c) are schematic representations illustrating configurations for the LCD panel of the liquid crystal display device shown in FIG. 1.

FIG. 22 is a partial cross-sectional view schematically illustrating a cross-sectional structure of the LCD panel of the liquid crystal display device shown in FIG. 1.

FIG. 23 is a plan view schematically illustrating a region allocated to one subpixel in the LCD panel of the liquid crystal display device shown in FIG. 1.

FIGS. 24(a) and 24(b) are plan views schematically illustrating a region allocated to one subpixel in the LCD panel of the liquid crystal display device shown in FIG. 1.

FIG. 25 is a plan view schematically illustrating a region allocated to one subpixel in the LCD panel of the liquid crystal display device shown in FIG. 1.

FIG. 26 is a schematic representation illustrating a configuration for the correcting section of a liquid crystal display device as a modified example of the preferred embodiment of the present invention.

FIG. 27 is a schematic representation illustrating a liquid crystal display device as a modified example of the preferred embodiment of the present invention.

### DESCRIPTION OF EMBODIMENTS

Hereinafter, preferred embodiments of a liquid crystal display device according to the present invention will be described with reference to the accompanying drawings. It should be noted, however, that the present invention is in no way limited to the specific preferred embodiments to be described below.

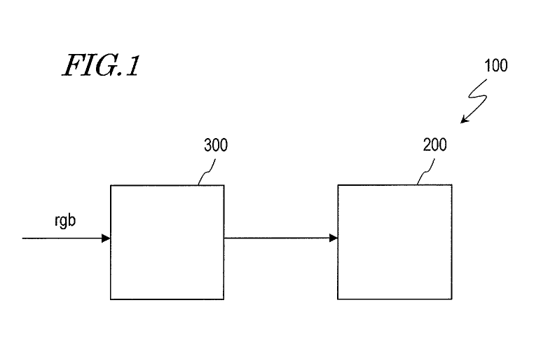

A specific preferred embodiment of a liquid crystal display device according to the present invention will now be described. FIG. 1 is a schematic representation illustrating a liquid crystal display device 100 as a preferred embodiment of the present invention. The liquid crystal display device 100 includes an LCD panel 200 and a correcting section 300. The LCD panel 200 has a number of pixels that are arranged in columns and rows to form a matrix pattern. In the LCD panel 200 of this preferred embodiment, each of those pixels includes red, green and blue subpixels. In the following description, the liquid crystal display device will sometimes be simply referred to herein as a “display device”.

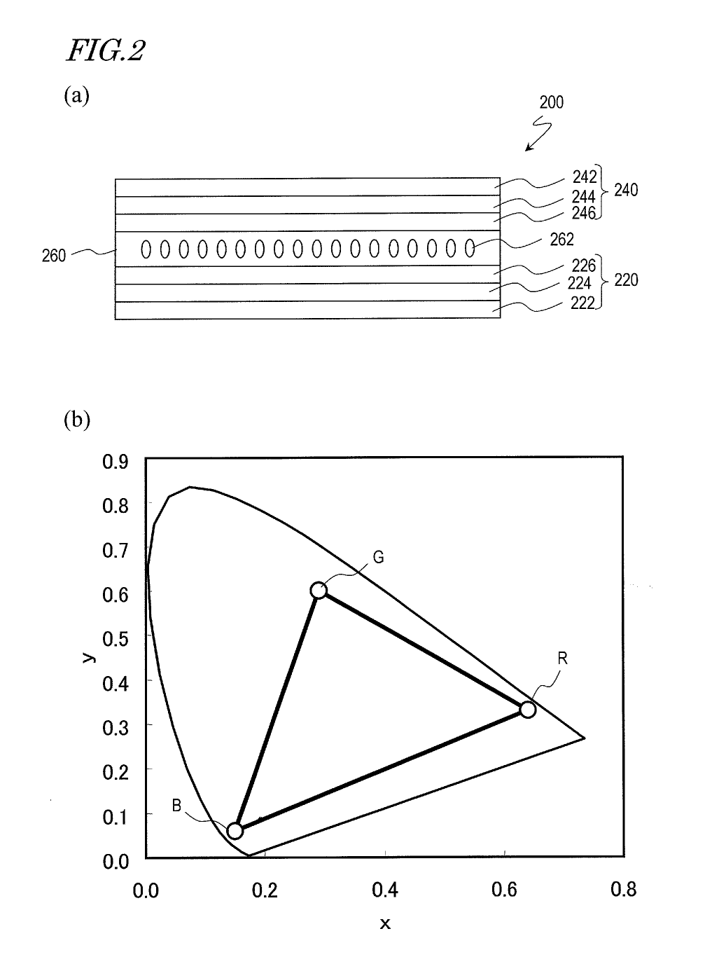

The input signal may be compatible with a cathode ray tube (CRT) with a γ value of 2.2 and is compliant with the NTSC (National Television Standards Committee) standard. The input signal represents the grayscale levels r, g and b of the red, green and blue subpixels. In general, the grayscale levels r, g and b are represented by eight bits. Or the input signal may have a value that can be converted into the grayscale levels r, g and b of red, green and blue subpixels and that is represented as a three-dimensional value. In FIG. 1, the grayscale levels r, g and b of the input signal are collectively identified by rgb. It should be noted that if the input signal is compliant with the BT. 709 standard, the grayscale levels r, g and b indicated by the input signal fall within the range of the lowest grayscale level (e.g., grayscale level 0) through the highest grayscale level (e.g., grayscale level 255) and the luminances of the red, green and blue subpixels fall within the range of zero through one. The input signal may be YCrCb signal, for example. The grayscale levels rgb indicated by the input signal are input through the correcting section 300 to the LCD panel 200, which converts the grayscale levels into luminance levels. As a result, voltages representing the luminance levels are applied to the liquid crystal layer 260 of the LCD panel 200 (see FIG. 2(a)).

As described above, in a three-primary-color liquid crystal display device, if either the grayscale levels or luminance levels of red, green and blue subpixels are all zero, a pixel displays the color black. On the other hand, if either the grayscale levels or luminance levels of red, green and blue subpixels are all one, then a pixel displays the color white. In a liquid crystal display device, if the highest luminance of red, green and blue subpixels after the color temperatures have been adjusted to the intended ones in a TV set is supposed to be one and if an achromatic color is going to be displayed, then the red, green and blue subpixels have either the same grayscale level or the same maximum luminance ratio of the luminance levels. That is why if the color represented by a pixel changes from black into white while remaining an achromatic color, then the grayscale level of the red, green and blue subpixels or the maximum luminance ratio of the luminance levels does increase but is still the same between those red, green and blue subpixels. In the following description, if the luminance of each subpixel in an LCD panel is the lowest one, then that subpixel will be referred to herein as an “OFF-state subpixel”. On the other hand, if the luminance of each subpixel is higher than that lowest luminance, then that subpixel will be referred to herein as an “ON-state subpixel”.

The grayscale levels rgb represented by the input signal are corrected by the correcting section 300 at least under a certain condition. For example, the correcting section 300 may perform no correction on the grayscale levels r and g represented by the input signal but may correct the grayscale level b into a grayscale level b′. In this liquid crystal display device 100, the variation in the chromaticity of an achromatic color when viewed obliquely can be reduced by the correcting section 300.

FIG. 2(a) is a schematic representation illustrating the LCD panel 200, which includes an active-matrix substrate 220 with pixel electrodes 224 and an alignment film 226 that have been stacked in this order on an insulating substrate 222, a counter substrate 240 with a counter electrode 244 and another alignment film 246 that have also been stacked in this order on another insulating substrate 242, and a liquid crystal layer 260, which is interposed between the active-matrix substrate 220 and the counter substrate 240. Although not shown, two polarizers are provided for the active-matrix substrate 220 and the counter substrate 240, respectively, and are arranged so that their polarization axes satisfy the crossed Nicols relation. Although not shown in FIG. 2(a), lines, insulating layers and other members are actually assembled on the active-matrix substrate 220, while a color filter layer is actually provided for the counter substrate 240. The liquid crystal layer 260 has a substantially uniform thickness. In the LCD panel 200, a number of pixels are arranged in columns and rows to form a matrix pattern. Each of those pixels is defined by an associated pixel electrode 224 and the red, green and blue subpixels are defined by divided subpixel electrodes of the pixel electrode 224. As will be described later, in this LCD panel 200, each subpixel electrode is further divided into multiple electrodes.

This LCD panel 200 operates in the VA mode. Thus, the alignment films 226 and 246 are vertical alignment films and the liquid crystal layer 260 is a vertical alignment liquid crystal layer. As used herein, the “vertical alignment liquid crystal layer” refers to a liquid crystal layer in which the axis of its liquid crystal molecules (which will be sometimes referred to herein as an “axial direction”) defines an angle of approximately 85 degrees or more with respect to the surface of the vertical alignment films 226 and 246. The liquid crystal layer 260 includes a nematic liquid crystal material with negative dielectric anisotropy. Using such a liquid crystal material along with two polarizers that are arranged as crossed Nicols, this device conducts a display operation in a normally black mode. Specifically, in that mode, when no voltage is applied to the liquid crystal layer 260, the liquid crystal molecules 262 in the liquid crystal layer 260 are aligned substantially parallel to a normal to the principal surface of the alignment films 226 and 246. On the other hand, when a voltage that is higher than a predetermined voltage is applied to the liquid crystal layer 260, the liquid crystal molecules 262 in the liquid crystal layer 260 are aligned substantially parallel to the principal surface of the alignment films 226 and 246. Also, when a high voltage is applied to the liquid crystal layer 260, the liquid crystal molecules 262 will be aligned symmetrically either within a subpixel or within a particular region of the subpixel, thus contributing to improving the viewing angle characteristic. In this example, each of the active-matrix substrate 220 and the counter substrate 240 has its alignment film 226, 246. However, according to the present invention, at least one of the active-matrix substrate 220 and the counter substrate 240 may have its alignment film 226 or 246. Nevertheless, in order to stabilize the alignments, it is still preferred that both of the active-matrix substrate 220 and the counter substrate 240 have their own alignment film 226, 246.

FIG. 2(b) shows an xy chromaticity diagram according to the XYZ color system, in which the triangle, formed by the three points corresponding to the three primary colors of red, green and blue, represents the color reproduction range of the LCD panel 200.

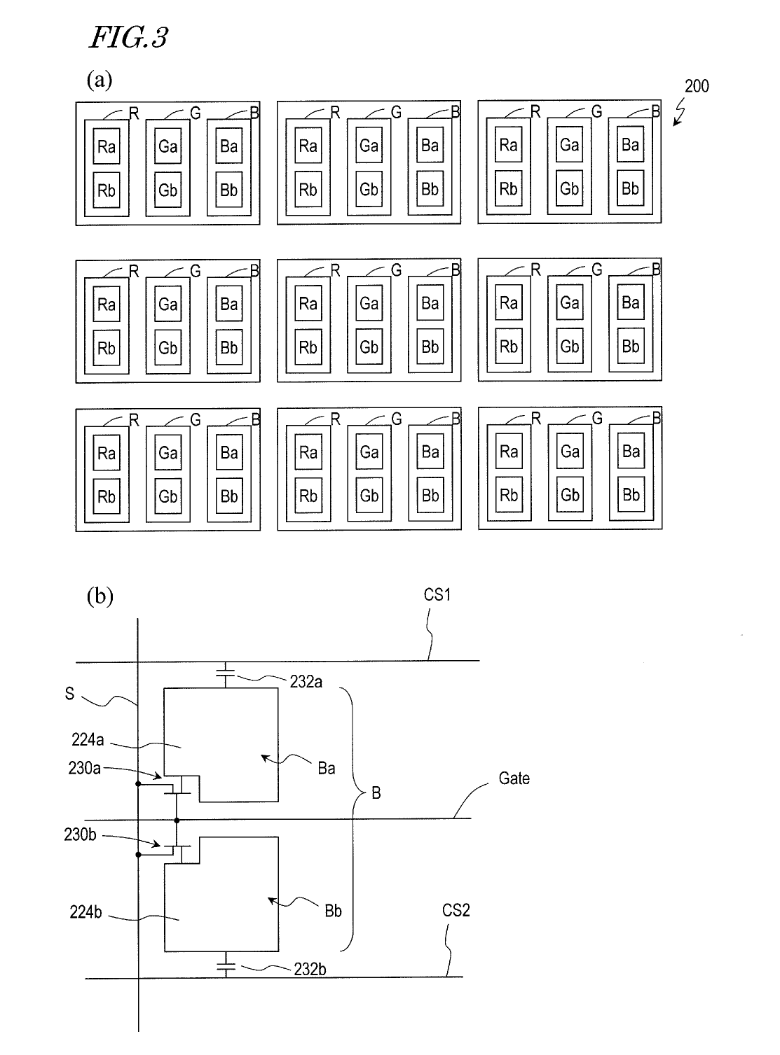

FIG. 3(a) illustrates how pixels and subpixels, included in each of those pixels, may be arranged in this LCD panel 200. As an example, FIG. 3(a) illustrates an arrangement of pixels in three columns and three rows. Each of those pixels includes three subpixels, which are red, green and blue subpixels R, G and B. In this LCD panel 200, one color is represented by one pixel consisting of the red, green and blue subpixels R, G and B. The luminances of these subpixels can be controlled independently of each other. It should be noted that the arrangement of color filters in the LCD panel 200 corresponds to the one shown in FIG. 3(a).

In this liquid crystal display device 100, each of the three subpixels R, G and B has two divided regions. Specifically, the red subpixel R has first and second regions Ra and Rb, the green subpixel G has first and second regions Ga and Gb, and the blue subpixel B has first and second regions Ba and Bb.

In each of these subpixels R, G and B, the luminance values of its multiple regions may be controlled to be different from each other. As a result, the viewing angle dependence of the gamma characteristic, which refers to a phenomenon that the gamma characteristic when the display screen is viewed straight on is different from the one when the display screen is viewed obliquely, can be reduced. Methods for reducing the viewing angle dependence of the gamma characteristic are disclosed in Japanese Patent Application Laid-Open Publications Nos. 2004-62146 and 2004-78157, for example. By controlling the luminances of multiple different regions of each of those subpixels R, G and B so that those luminances are different from each other, the viewing angle dependence of the gamma characteristic can be reduced as well as is disclosed in Japanese Patent Application Laid-Open Publications Nos. 2004-62146 and 2004-78157. Such a red, green and blue (R, G and B) structure is also called a “divided structure”. In the following description, one of the first and second regions that has the higher luminance will sometimes be referred to herein as a “bright region” and the other region with the lower luminance as a “dark region”.

In the following description, a subpixel's luminance level corresponding to the lowest grayscale level (e.g., grayscale level 0) will be represented herein as “0” and a subpixel's luminance level corresponding to the highest grayscale level (e.g., grayscale level 255) will be represented herein as “1” for convenience sake. Even if their luminance levels are equal to each other, the red, green and blue subpixels may actually have mutually different luminances because the “luminance level” herein means the ratio of the luminance of each subpixel to its highest luminance. For example, if the input signal indicates that a pixel should represent the color black, all of the grayscale levels r, g and b indicated by the input signal are the lowest grayscale level (e.g., grayscale level 0). On the other hand, if the input signal indicates that a pixel should represent the color white, all of the grayscale levels r, g and b are the highest grayscale level (e.g., grayscale level 255). In the following description, the grayscale level will sometimes be normalized with the highest grayscale level and the grayscale level will be represented as a ratio of zero through one.

In this liquid crystal display device 100, if the lightness of an achromatic color changes from black toward white, the grayscale levels of the respective subpixels represented by the input signal increase at the same rate. Specifically, the color represented initially by a pixel is black and the luminances of its red, green and blue subpixels are zero. When the grayscale levels of red, green and blue subpixels start to increase, the luminance starts to increase in one of the two regions of each subpixel (which will be the bright region). And when the increasing luminance of the bright region reaches a predetermined value, the luminance starts to increase in the other region (which will be the dark region). The more the grayscale levels of red, green and blue subpixels increase at the same rate, the higher the lightness of the achromatic color represented by the pixel. And when the increasing luminances of the red, green and blue subpixels reach one, the color represented by the pixel becomes white.

FIG. 3(b) illustrates a configuration for a blue subpixel B in this liquid crystal display device 100. Although not shown in FIG. 3(b), the other red and green subpixels R and G also have the same configuration.

The blue subpixel B has two regions Ba and Bb that are defined by divided electrodes 224a and 224b, respectively. A TFT 230a and a storage capacitor 232a are connected to the divided electrode 224a and a TFT 230b and a storage capacitor 232b are connected to the divided electrode 224b. The TFTs 230a and 230b have their respective gate electrodes connected to the same gate bus line Gate and have their respective source electrodes connected in common to the same source bus line S. The storage capacitors 232a and 232b are connected to CS bus lines CS1 and CS2, respectively. The storage capacitor 232a is formed by a storage capacitor electrode that is electrically connected to the divided electrode 224a, a storage capacitor counter electrode that is electrically connected to the CS bus line CS1, and an insulating layer (not shown) that is arranged between those two electrodes. Likewise, the storage capacitor 232b is formed by a storage capacitor electrode that is electrically connected to the divided electrode 224b, a storage capacitor counter electrode that is electrically connected to the CS bus line CS2, and an insulating layer (not shown) that is arranged between those two electrodes. The storage capacitor counter electrodes of the storage capacitors 232a and 232b are independent of each other and can be supplied with mutually different storage capacitor counter voltages through the CS bus lines CS1 and CS2, respectively. Thus, after a voltage has been applied to the divided electrodes 224a and 224b through the source bus line S while the TFTs 230a and 230b are in ON state, the TFTs 230a and 230b may turn OFF and the potentials on the CS bus lines CS1 and CS2 may vary into different values. In that case, the divided electrode 224a will have a different effective voltage from the divided electrode 224b. As a result, the first region Ba comes to have a different luminance from the second region Bb.

The liquid crystal display device 100 of this preferred embodiment makes the correcting section 300 shown in FIG. 1 adjust the luminances of two blue subpixels, which belong to two adjacent pixels, as a unit at least under a certain condition. For example, even if the input signal indicates that the blue subpixels belonging to two adjacent pixels have the same grayscale level, the correcting section 300 may correct the grayscale level so that those two blue subpixels will have mutually different luminances in the LCD panel 200. In the following description, one of those two blue subpixels that has the higher luminance will be referred to herein as the “bright blue subpixel”, while the other blue subpixel with the lower luminance as the “dark blue subpixel”. In this LCD panel 200, the sum of the respective luminances of the blue subpixels belonging to two adjacent pixels corresponds to the sum of respective luminances corresponding to the respective grayscale levels of the two adjacent blue subpixels as represented by the input signal. The correcting section 300 may make correction on the grayscale levels of the blue subpixels belonging to two pixels that are adjacent to each other in the row direction.

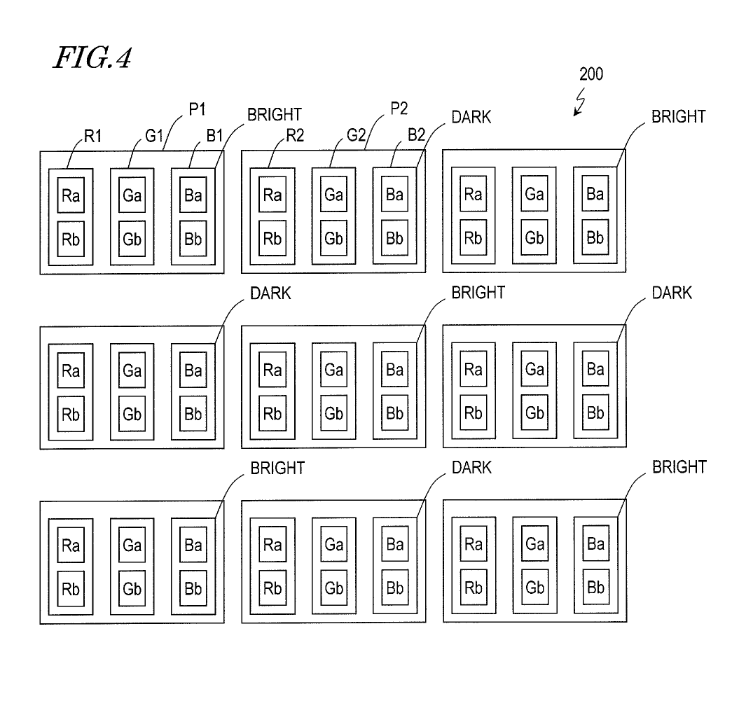

FIG. 4 illustrates the LCD panel 200 of the liquid crystal display device 100. In FIG. 4, two pixels that are adjacent to each other in the row direction are taken as an example. One of those two pixels is identified by P1 and its red, green and blue subpixels are identified by R1, G1 and B1, respectively. The other pixel is identified by P2 and its red, green and blue subpixels are identified by R2, G2 and B2, respectively.

For example, if the input signal indicates that the color to be represented by all pixels be an achromatic color at a certain middle grayscale, the luminances of the red and green subpixels R1 and G1 belonging to one P1 of the two adjacent pixels of the LCD panel 200 are equal to those of the red and green subpixels R2 and G2 belonging to the other pixel P2. However, the luminance of the blue subpixel B1 belonging to the one pixel P1 is different from that of the blue subpixel B2 belonging to the other pixel P2. In the example illustrated in FIG. 4, the luminances of blue subpixels belonging to pixels that are adjacent to each other in the row direction invert every column.

In this example, the input signal is supposed to indicate that the color to be represented by all pixels be an achromatic color at the same grayscale level, which will be referred to herein as a “reference grayscale level”. In this liquid crystal display device 100, although the two regions in each blue subpixel have different luminances, the overall luminance of each blue subpixel itself is equal to the luminance corresponding to the reference grayscale level. Also, when attention is paid to blue subpixels belonging to pixels on a certain row, it can be seen that a blue subpixel, of which the luminance is higher than the luminance corresponding to the reference grayscale level, alternates with a blue subpixel, of which the luminance is lower than that luminance. Likewise, the luminances of blue subpixels belonging to pixels that are adjacent to each other in the column direction also invert one row after another.

As described above, in the liquid crystal display device 100 of this preferred embodiment, the correcting section 300 makes a correction so that one of the two blue subpixels belonging to those two adjacent pixels has its luminance increased by the magnitude of shift ΔSα and the other blue subpixel has its luminance decreased by the magnitude of shift ΔSβ. Consequently, those two blue subpixels belonging to the two adjacent pixels have mutually different luminances. In this case, the luminance of the bright blue subpixel is higher than the luminance corresponding to the reference grayscale level, while that of the dark blue subpixel is lower than the luminance corresponding to the reference grayscale level. Also, the difference between the luminance of the bright blue subpixel and the luminance corresponding to the reference grayscale level is substantially equal to the difference between the luminance corresponding to the reference grayscale level and the luminance of the dark blue subpixel. And ideally, ΔSα=ΔSβ is satisfied. As described above, each subpixel of the LCD panel 200 has multiple regions. Thus, each bright blue subpixel has a bright region and a dark region, so does each dark blue subpixel. The luminance in the bright region of the bright blue subpixel is higher than in the counterpart of the dark blue subpixel. And the luminance in the dark region of the dark blue subpixel is lower than in the counterpart of the bright blue subpixel.

The liquid crystal display device 100 of this preferred embodiment may be fabricated in the following manner. First of all, an LCD panel 200 is provided. As described above, the LCD panel 200 includes an active-matrix substrate 220, a counter substrate 240 and a vertical alignment liquid crystal layer 260 interposed between the active-matrix substrate 220 and the counter substrate 240. The LCD panel 200 has a number of pixels, each of which includes multiple subpixels that include red, green and blue subpixels. And each of the subpixels has multiple regions, of which the luminances may be different from each other. At this stage, no setting has been done yet to adjust the luminances of the respective blue subpixels in the LCD panel 200. And if the input signal indicates that two adjacent pixels should represent an achromatic color with the same grayscale level, blue subpixels belonging to two adjacent pixels in the LCD panel 200 have the same luminance.

Next, the chromaticity characteristic of the LCD panel 200 is measured. It will be described with reference to FIG. 5 how to measure the chromaticity characteristic of the LCD panel 200. FIG. 5(a) is a schematic representation illustrating how to measure the chromaticity when the LCD panel 200 is viewed straight on.

In response to a signal that has been received from a signal generator 510, an achromatic color or a single color red, green or blue is displayed on the entire screen of the LCD panel 200. A meter 520 is arranged right in front of the screen of the LCD panel 200 in order to measure the luminance and chromaticity of the LCD panel 200.

A controller 530 controls the signal generator 510 and the meter 520 and may be a personal computer, for example. By automatically changing the grayscale level of the achromatic color as indicated by the input signal received from the signal generator 510 from the lowest grayscale level (which may be grayscale level 0 and corresponds to the color black) through the highest grayscale level (which may be grayscale level 255 and corresponds to the color white) one level after another, the controller 530 gets the chromaticity on the LCD panel 200 measured by the meter 520 with respect to each grayscale level and records the chromaticity measured. In this manner, the chromaticity values x and y on the LCD panel 200 when viewed straight on are obtained with respect to each grayscale level. If a backlight is attached to the LCD panel 200, it is preferred that it is not until the luminance of the backlight gets stabilized that such measurements are started.

On the other hand, FIG. 5(b) is a schematic representation illustrating how to measure the chromaticity when the LCD panel 200 is viewed obliquely. In FIG. 5(b), only the arrangement of the meter 520 with respect to the LCD panel 200 is shown and neither the signal generator 510 nor the controller 530 is shown for the sake of simplicity. In this case, the meter 520 is arranged obliquely with respect to the LCD panel 200 so as to define a tilt angle of 60 degrees with respect to a normal to its display screen.

In such an arrangement, while adjusting the magnitudes of shift ΔSα and ΔSβ of the luminances of the respective blue subpixels belonging to two adjacent pixels within their adjustable range with respect to each grayscale level of the achromatic color as indicated by the input signal supplied from the signal generator 510, the controller 530 gets the chromaticity values x and y on the LCD panel 200 when viewed obliquely obtained by the meter 520 and then records the chromaticity values thus obtained. In this manner, the adjustable range of the chromaticity of the LCD panel 200 when viewed obliquely can be determined with respect to each grayscale level.

Such measurement is carried out on every one of the grayscale levels of the achromatic color that is indicated by the input signal supplied from the signal generator 510. That is to say, the measurement is done on the entire grayscale level range from the lowest grayscale level (which may be grayscale level 0 and corresponds to the color black) through the highest grayscale level (which may be grayscale level 255 and corresponds to the color white). As a result, the chromaticity adjustable range is obtained with respect to each and every grayscale level. It should be noted that the chromaticity adjustable range of the LCD panel 200 as viewed obliquely does not have to be measured actually, but may be determined by simulation, with respect to each grayscale level. The simulations for defining the adjustable range may be carried out in the following manner. Specifically, the difference in luminance level between two blue subpixels is gradually increased from zero through the luminances corresponding to the highest and lowest output grayscale levels so that the average of the luminance levels of two adjacent blue subpixels does not change from one grayscale level to another. And every time the luminance level difference is increased, the chromaticity when viewed obliquely is calculated based on the values measured obliquely. Among the chromaticity values thus calculated, those between the highest and lowest chromaticity values define the adjustable range. As will be described later with reference to FIG. 7, the grayscale characteristic of the LCD panel 200 when viewed obliquely does not vary simply. That is why the highest chromaticity or the lowest chromaticity is not always observed even if the difference in luminance between the blue subpixels is maximum.

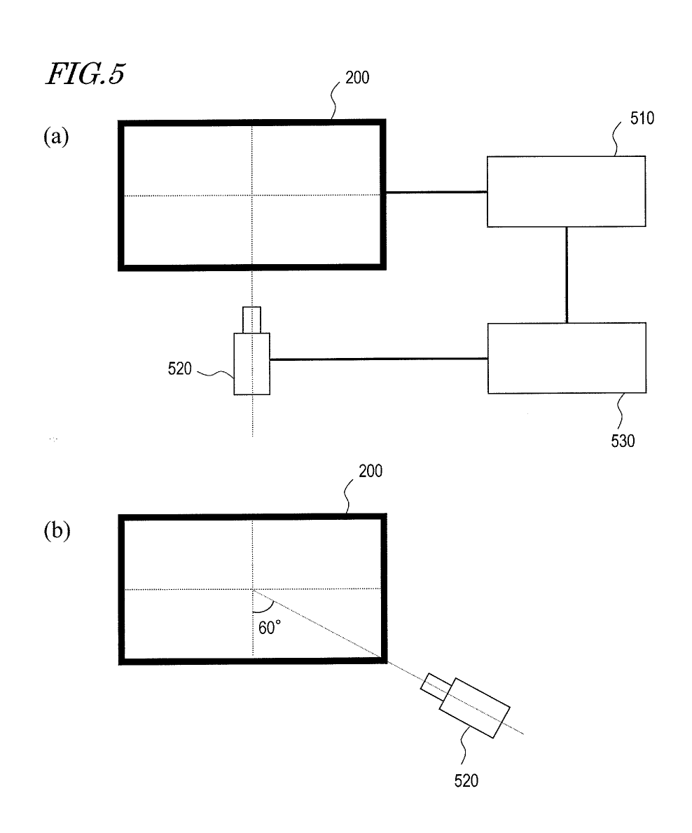

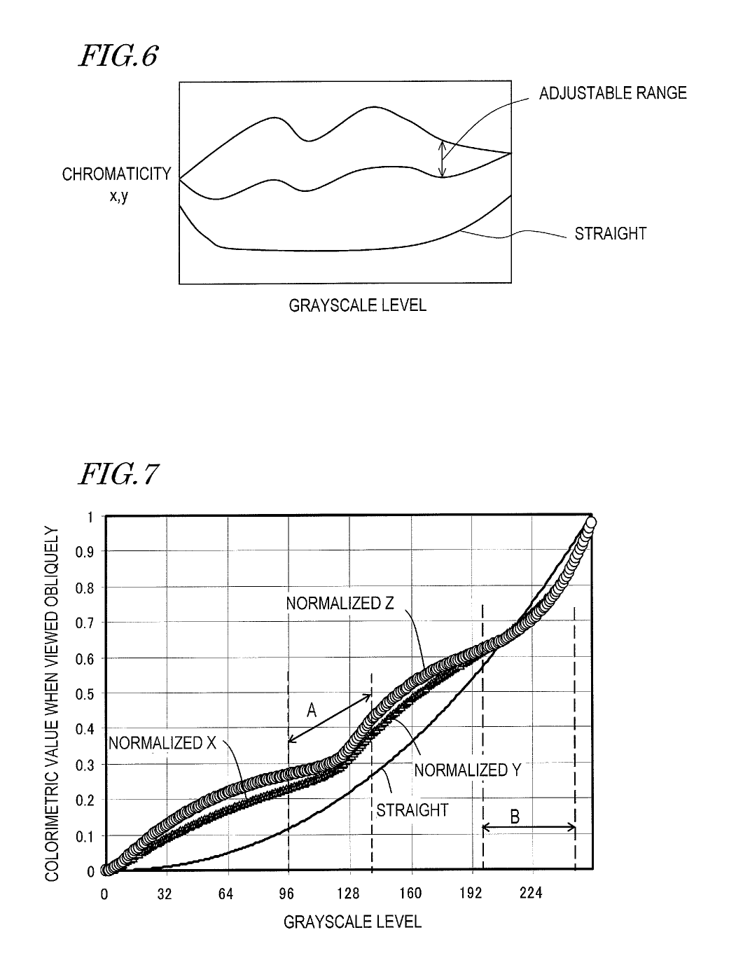

FIG. 6 schematically shows how the chromaticity as viewed straight on and the chromaticity adjustable range as viewed obliquely change with the grayscale level. Strictly speaking, the chromaticity value x should change differently from the chromaticity value y. In FIG. 6, however, both of these chromaticity values x and y are supposed to change in the same way with the grayscale level for the sake of simplicity. Also, at every grayscale level, the chromaticity values x and y as viewed obliquely are always higher than the chromaticity value x and y as viewed straight on. In this case, the chromaticity values x and y as viewed straight on are not constant, either. However, independent gamma correction processing may be carried out as will be described later. In that case, not just can the color temperature be corrected but also can the variation in chromaticity as viewed straight on with the grayscale level be reduced as well.

Next, at each grayscale level, the luminances of blue subpixels are set so that the chromaticity as viewed obliquely, which falls within the adjustable range, becomes as close to the chromaticity on the LCD panel as viewed straight on as possible. In the graph shown in FIG. 6, in the entire grayscale level range, any arbitrary chromaticity as viewed obliquely is higher than the chromaticity as viewed straight on. That is why the luminances of blue subpixels are set so that the chromaticity as viewed obliquely that falls within the adjustable range becomes closest to the chromaticity as viewed straight on with respect to each grayscale level. As a result, the difference between the chromaticity as viewed obliquely and the chromaticity as viewed straight on can be reduced and the decline in display quality can be minimized. Such settings may be done by the correcting section 300, which may be implemented as an LSI (large scale integrated circuit) attached to the LCD panel 200. In this manner, the liquid crystal display device 100 of this preferred embodiment can be fabricated.

Optionally, in order to reduce the variation in the chromaticity of an achromatic color when viewed obliquely, the luminances of blue subpixels could be set so that the chromaticity as viewed obliquely becomes constant irrespective of any variation in grayscale level and regardless of the chromaticity as viewed straight on. In that case, since the chromaticity of the achromatic color as viewed obliquely never changes, the display quality seems to have improved. If such settings are adopted, however, the difference between the chromaticity as viewed obliquely and the chromaticity as viewed straight on is so big that the achromatic color as viewed obliquely will look yellowish compared to the same achromatic color as viewed straight on. On the other hand, the liquid crystal display device 100 of this preferred embodiment sets the luminances of blue subpixels so that the chromaticity as viewed obliquely that does fall within the adjustable range becomes as close to the chromaticity as viewed straight on as possible. Consequently, the difference between the chromaticity of an achromatic color as viewed straight on and that of the same achromatic color as viewed obliquely can be reduced significantly.

Provided that the correcting section 300 would make no adjustment at all on the luminances of blue subpixels with respect to any grayscale level, an achromatic color displayed on the LCD panel 200 could sometimes look yellowish when viewed obliquely.

FIG. 7 shows how the colorimetric values as viewed obliquely change with the lightness of an achromatic color on the LCD panel 200. In FIG. 7, the normalized X, Y and Z values were obtained by normalizing variations in colorimetric values X, Y and Z, which were obtained by viewing the colors obliquely (e.g., at a tilt angle of 60 degrees with respect to a normal to the display screen), with the grayscale level with the luminance corresponding to the highest grayscale level (e.g., grayscale level 255 in this example) supposed to be one. In this case, the correcting section 300 does not adjust the luminances of blue subpixels at any grayscale level.

In this LCD panel 200, the normalized X, Y and Z values as viewed straight on changed in the same way. Thus, in FIG. 7, the variations in the normalized X, Y and Z values as viewed straight on are collectively identified by “straight”. For example, a luminance corresponding to a half of the highest grayscale level (i.e., grayscale level 128 in this example) is 0.21 and a luminance corresponding to a quarter of the highest grayscale level (i.e., grayscale level 64 in this example) is 0.05.

In this LCD panel 200, each subpixel is divided into two regions and the whitening phenomenon has been reduced to a certain degree. However, to further reduce the whitening phenomenon, all of the normalized X, Y and Z values as viewed obliquely should be as low as the ones as viewed straight on from low grayscales through high grayscales. Furthermore, comparing the variations in the normalized X, Y, and Z values to each other, it can be seen that the normalized X and Y values change in substantially the same way and that the normalized Z value is greater than the normalized X and Y values from low grayscales through middle grayscales, once gets equal to the normalized X and Y values at the middle grayscales, exceeds the normalized X and Y values again at more than the middle grayscales, but becomes smaller than the normalized X and Y values once the grayscale level exceeds 200.

As can be seen, if the LCD panel 200 changes the lightness of an achromatic color while keeping it achromatic, the normalized Z value is greater than the normalized X and Y values from low through middle grayscales and from the middle grayscales through the grayscale level 200. But at around the middle grayscales and at more than the grayscale level 200, the normalized Z value becomes equal to or smaller than the normalized X and Y values. That is why if the color as viewed obliquely is compared to the color viewed straight on, the color viewed obliquely will look more bluish than the color viewed straight on from low through middle grayscales and from the middle grayscales through the grayscale level 200.

Meanwhile, if the grayscale level is changed with the achromatic color kept achromatic and with the viewing direction kept oblique, then the color will look relatively yellowish at middle grayscales and at more than the grayscale level 200. In the following description, such a phenomenon that an achromatic color looks yellowish will be referred to herein as a “yellow shift”. Such a yellow shift occurs in a range where the difference between the normalized Z value and the normalized X and Y values decreases (i.e., in the range A shown in FIG. 7) and in a range where the normalized Z value becomes smaller than the normalized X and Y values (i.e., in the range B shown in FIG. 7).

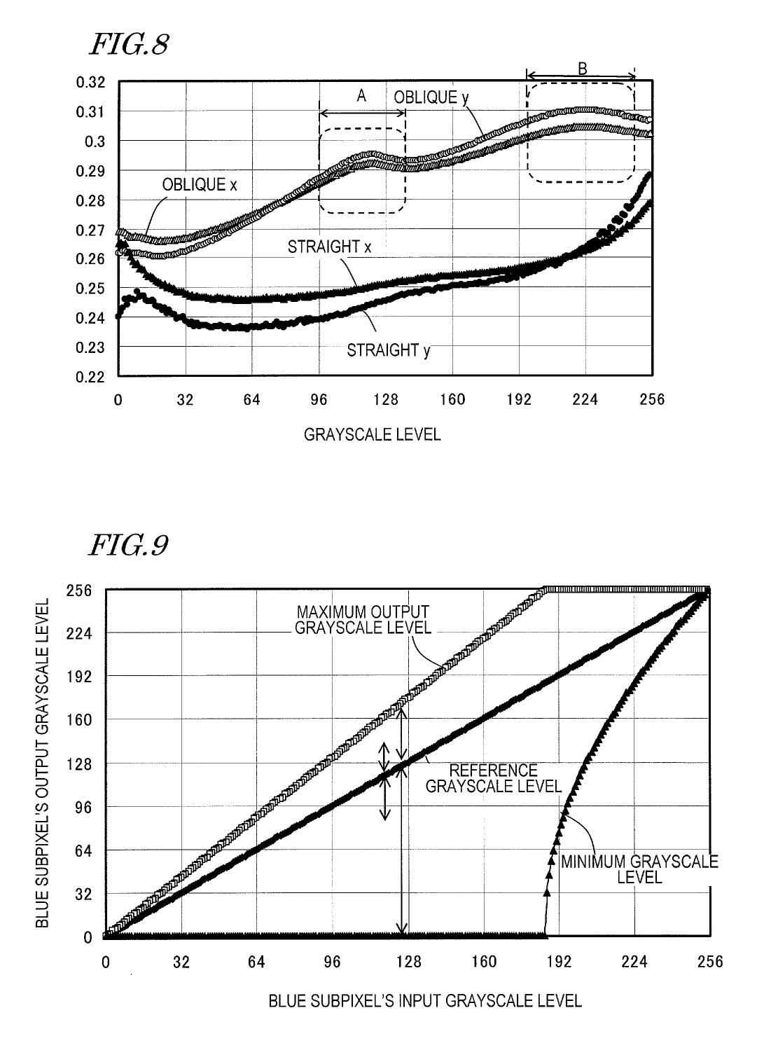

FIG. 8 shows how x and y vary when the LCD panel 200 is viewed straight on and when the LCD panel 200 is viewed obliquely in a situation where the correcting section 300 does not adjust the luminances of blue subpixels at any grayscale level. In the grayscale level ranges A and B where the yellow shift occurs, the chromaticity inverts as the grayscale level changes.

As can be seen, in such a situation where the luminances of blue subpixels are not adjusted, when the normalized Z value becomes equal to or smaller than the normalized X or Y value, the yellow shift occurs. That is why the yellow shift would be suppressible just by appropriately controlling the normalized Z value, even if the normalized X or Y value when viewed obliquely is not changed. Also, generally speaking, a variation in the luminance of a blue subpixel will affect significantly the normalized Z value but will not affect the normalized X and Y values so much. Thus, the yellow shift should be suppressible efficiently if the luminance of a blue subpixel is adjusted by the correcting section 300. For that reason, in the liquid crystal display device 100 of this preferred embodiment, the luminances of blue subpixels are adjusted by the correcting section 300.

Also, if the luminances of blue subpixels are adjusted, the resolution of the color blue will decrease, strictly speaking. Actually, however, that decrease in the resolution of the color blue is not easily sensible to the human viewer's eye in an achromatic color or in a nearly achromatic color. This is because to the human eye, the resolution of the color blue is lower than that of any other color. Particularly when each of the subpixels of a pixel is turned ON as in representing an achromatic color in a middle grayscale tone, if the resolution nominally decreases in the blue subpixel, the decrease in the substantial resolution is hardly sensible. In view of this consideration, it is more effective to correct the grayscale level of the blue subpixels than doing the same for subpixels of any other color.

That is why in this liquid crystal display device 100, the luminances of blue subpixels are set so as to be adjusted under at least a certain condition. Before setting the luminances of blue subpixels, the liquid crystal display device 100 obtains the adjustable range of the chromaticity when viewed obliquely.

FIG. 9 shows how the output grayscale level of a blue subpixel changes according to its input grayscale level in the liquid crystal display device 100 of this preferred embodiment. If no corrections are made by the correcting section 300, then the output grayscale level will be the reference grayscale level. However, if the luminances are adjusted by the correcting section 300 in the maximum range, the blue subpixel belonging to one of two adjacent pixels will have the maximum output grayscale level while the blue subpixel belonging to the other pixel will have the minimum output grayscale level. According to the degree of the luminance adjustment made by the correcting section 300, the output grayscale level associated with each input grayscale level varies within the range between the maximum and minimum output grayscale levels with respect to the reference grayscale level. It should be noted that the grayscale levels of bright and dark blue subpixels are set so that the average luminance of the bright and dark blue subpixels becomes constant with respect to a certain grayscale level.

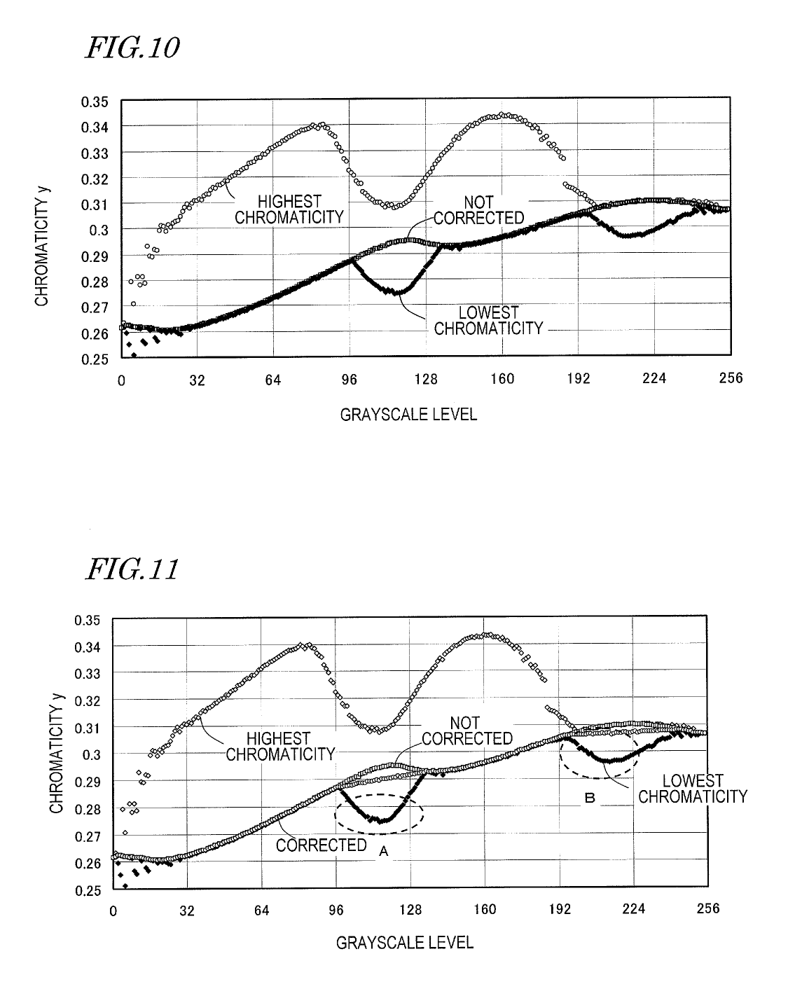

FIG. 10 shows the chromaticity y adjustable range of the LCD panel 200. In FIG. 10, with respect to each grayscale level, the highest value in the adjustable range is labeled as the “highest chromaticity” and the lowest value in the adjustable range is labeled as the “lowest chromaticity”. As long as the chromaticity falls within the adjustable range, the chromaticity can be set to be any arbitrary value by adjusting the luminances of blue subpixels belonging to two pixels. In FIG. 10, it is also shown for your reference how the chromaticity when viewed obliquely varies if no correction is made by the correcting section 300. And this variation is an enlargement of the “oblique y” shown in FIG. 8. As already described with reference to FIG. 6, the chromaticity y when viewed straight on is lower than any arbitrary chromaticity in the adjustable range when viewed obliquely. That is why the chromaticity y when the LCD panel 200 is viewed obliquely is adjusted to be the lowest chromaticity in the adjustable range.

Specifically, if no correction is made by the correcting section 300 in the range from the grayscale level 0 through the level 95, the chromaticity when the LCD panel 200 is viewed obliquely becomes the lowest one in the adjustable range. Likewise, if no correction is made by the correcting section 300 in the range from the grayscale level 137 through the level 194 and in the range from the grayscale level 246 through the level 255, the chromaticity when the LCD panel 200 is viewed obliquely becomes the lowest one in the adjustable range. That is why by getting no correction made by the correcting section 300 when the grayscale level represented by the input signal falls within the range from the grayscale level 0 through the level 95, the range from the grayscale level 137 through the level 194 or the range from the grayscale level 246 through the level 255, the chromaticity when the LCD panel 200 is viewed obliquely can be the lowest one in the adjustable range.

On the other hand, if no correction is made on the luminances of blue subpixels by the correcting section 300 in the range from the grayscale level 96 through the level 136 and in the range from the grayscale level 195 through the level 245, the chromaticity when the LCD panel 200 is viewed obliquely becomes different from the lowest one in the adjustable range. In that case, by setting the luminances of blue subpixels so that the chromaticities of pixels becomes the lowest one on the LCD panel 200, the difference in chromaticity between when viewed obliquely and when viewed straight on can be reduced. In such a situation, there is a relatively big difference in chromaticity between two significantly different grayscale levels (e.g., grayscale levels 30 and 224). However, since there is a relatively little difference in chromaticity between consecutive grayscale levels, the variation in chromaticity according to the grayscale level is not a serious problem.

Although not shown, as the chromaticity x when the LCD panel 200 is viewed straight on is lower than an arbitrary chromaticity falling within the adjustable range when viewed obliquely, the chromaticity x when the LCD panel 200 is viewed obliquely is adjusted to be the lowest one in the adjustable range. Specifically, by getting no correction made by the correcting section 300 when the grayscale level falls within the range from the grayscale level 0 through level 95, the range of level 137 through the level 194 or the range of level 246 through 255, the chromaticity when the LCD panel 200 is viewed obliquely becomes the lowest one in the adjustable range. On the other hand, by getting a correction made by the correcting section 300 when the grayscale level falls within the range of level 96 through level 137 or the range of level 195 through 245, the chromaticity when the LCD panel 200 is viewed obliquely becomes the lowest one in the adjustable range.

As can be seen from FIG. 10, if a curve drawn by connecting together the respective lowest chromaticities in the adjustable ranges that are associated with the respective grayscale levels is called a “lowest chromaticity curve”, then the lowest chromaticity curve will have four inflection points and will have a dent between each pair of adjacent inflection points. If the lowest chromaticity curve has inflection points in this manner, the chromaticity of an achromatic color will change relatively significantly between the adjacent inflection points. As a result, when the LCD panel 200 is viewed obliquely, an achromatic color will sometimes look bluish.

In that case, the luminances of blue subpixels may be set so that the chromaticity ideally changes almost linearly between two adjacent inflection points. With such settings adopted, at grayscale levels between the two adjacent inflection points, the chromaticity when viewed obliquely becomes a value between a chromaticity when no correction is made by the correcting section 300 and the lowest chromaticity in the adjustable range. As a result, it is possible to prevent the achromatic color from getting bluish when the LCD panel 200 is viewed obliquely.

FIG. 11 shows how the chromaticity y changes on the LCD panel 200. In this case, as no correction is made by the correcting section 300 in the range from the grayscale level 0 through the level 95, the chromaticity when the LCD panel 200 is viewed obliquely becomes the lowest one in the adjustable range. Likewise, as no correction is made by the correcting section 300 in the range from the grayscale level 137 through the level 194 and in the range from the grayscale level 246 through the level 255, the chromaticity when the LCD panel 200 is viewed obliquely becomes the lowest one in the adjustable range. That is why by getting no correction made by the correcting section 300 when the grayscale level represented by the input signal falls within the range from the grayscale level 0 through the level 95, the range from the grayscale level 137 through the level 194 or the range from the grayscale level 246 through the level 255, the chromaticity when the LCD panel 200 is viewed obliquely can be the lowest one in the adjustable range.

On the other hand, in the range A from the grayscale level 96 through the level 136 and in the range B from the grayscale level 195 through the level 245, a correction is made by the correcting section 300. In this case, however, the luminances of blue subpixels are set so that the chromaticity changes almost linearly between two adjacent inflection points. Also shown in FIG. 11 for your reference is how the chromaticity varies when no correction is made by the correcting section 300. In that case, when the LCD panel 200 is viewed obliquely, a yellow shift will be observed.

FIG. 12 shows how the chromaticity x changes on the LCD panel 200. As in the case of the chromaticity y, as no correction is made by the correcting section 300 for the chromaticity x in the range from the grayscale level 0 through the level 95, the chromaticity when the LCD panel 200 is viewed obliquely becomes the lowest one in the adjustable range. Likewise, as no correction is made by the correcting section 300 in the range from the grayscale level 137 through the level 194 and in the range from the grayscale level 246 through the level 255, the chromaticity when the LCD panel 200 is viewed obliquely becomes the lowest one in the adjustable range. That is why by getting no correction made by the correcting section 300 when the grayscale level represented by the input signal falls within the range from the grayscale level 0 through the level 95 or the range from the grayscale level 137 through the level 194, the chromaticity when the LCD panel 200 is viewed obliquely can be the lowest one in the adjustable range.

On the other hand, in the range A from the grayscale level 96 through the level 136 and in the range B from the grayscale level 195 through the level 245, a correction is made by the correcting section 300. As a result, the luminances of blue subpixels are set so that the chromaticity changes almost linearly between two adjacent inflection points. Also shown in FIG. 12 for your reference is how the chromaticity varies when no correction is made by the correcting section 300. In that case, when the LCD panel 200 is viewed obliquely, a yellow shift will be observed.

In the liquid crystal display device 100 with such settings, a correction may or may not be made by the correcting section 300 depending on what range the grayscale level of the achromatic color represented by the input signal belongs to. Specifically, unless the grayscale level of the achromatic color represented by the input signal falls within the range A or B, no correction is made by the correcting section 300. And in the liquid crystal display device 100, the luminances of the blue subpixels belonging to two pixels become equal to each other. On the other hand, if the grayscale level of the achromatic color represented by the input signal falls within the range A or B, a correction is made by the correcting section 300. And in the liquid crystal display device 100, the luminances of the blue subpixels belonging to two pixels become different from each other. Since only required portions are subjected to the correction by getting the correction made by the correcting section 300 selectively depending on whether the grayscale level falls within a predetermined range or not, middle grayscale tones can be displayed with more stability and the correction adjustment time can be shortened compared to a situation where correction is made at every grayscale level.

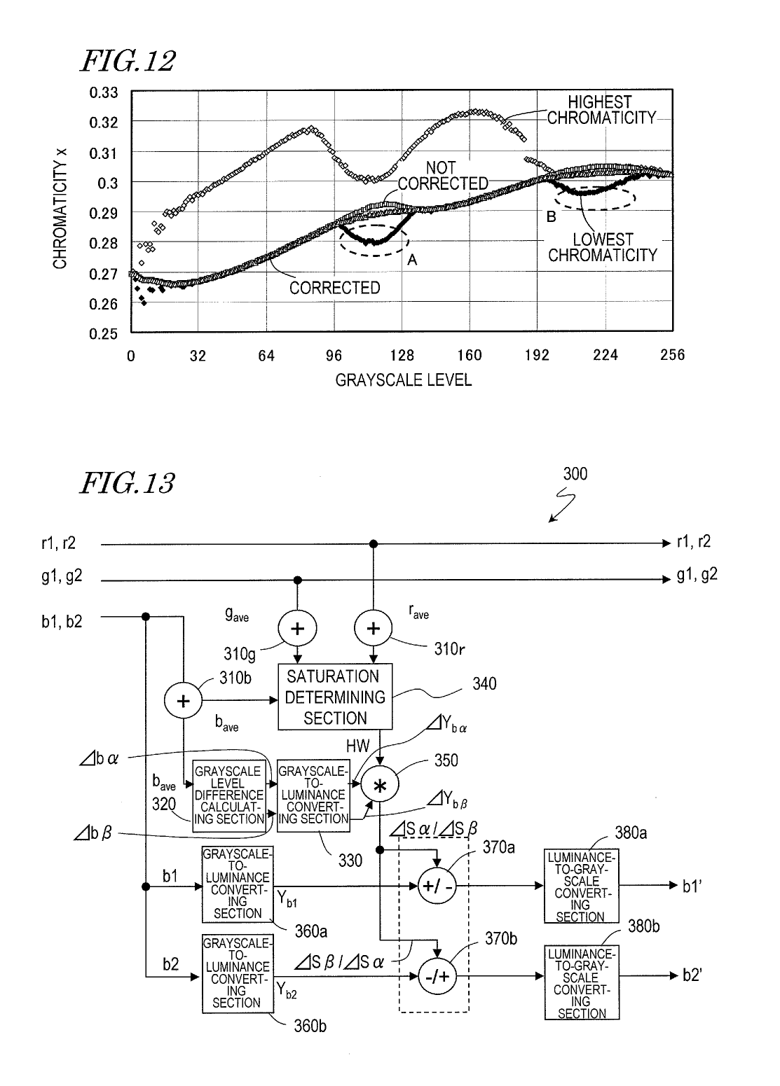

Hereinafter, a specific configuration for the correcting section 300 will be described with reference to FIG. 13. In FIG. 13, the grayscale levels r1, g1 and b1 are indicated by the input signal for the respective subpixels R1, G1 and B1 of the pixel P1 shown in FIG. 4, while the grayscale levels r2, g2 and b2 are indicated by the input signal for the respective subpixels R2, G2 and B2 of the pixel P2. Although the grayscale levels r1, r2, g1 and g2 are not corrected by the correcting section 300, the grayscale levels b1 and b2 are corrected in the following manner. The correcting section 300 obtains the magnitudes of shift ΔSα and ΔSβ in the luminance level of the blue subpixels B1 and B2.

First of all, the average of the grayscale levels b1 and b2 is calculated by using an adding section 310b. In the following description, the average of the grayscale levels b1 and b2 will be referred to herein as an average grayscale level bₐᵥₑ.

Next, a grayscale level difference calculating section 320 calculates two grayscale level differences Δbα and Δbβ with respect to the single average grayscale level bₐᵥₑ. The grayscale level differences Δbα and Δbβ are associated with a bright blue subpixel and a dark blue subpixel, respectively.

In this manner, the grayscale level difference calculating section 320 calculates two grayscale level differences Δbα and Δbβ with respect to the single average grayscale level bₐᵥₑ. The grayscale level difference calculating section 320 may determine the grayscale level differences Δbα and Δbβ with respect to the average grayscale level bₐᵥₑ by reference to a lookup table. Alternatively, the grayscale level difference calculating section 320 may also determine the grayscale level differences Δbα and Δbβ by performing predetermined computations on the average grayscale level bₐᵥₑ.

Next, a grayscale-to-luminance converting section 330 converts the grayscale level differences Δbα and Δbβ into luminance level differences ΔY_{b}α and ΔY_{b}β, respectively. In this case, the greater the luminance level difference ΔY_{b}α, ΔY_{b}β, the greater the magnitude of shift ΔSα, ΔSβ.

The higher the saturation of the pixel color indicated by the input signal, the less easily the yellow shift will be sensed. Conversely, the closer to an achromatic color the pixel color indicated by the input signal, the more easily the yellow shift will be sensed. In this manner, the degree of the yellow shift sensed varies according to the pixel color indicated by the input signal. The pixel color indicated by the input signal is reflected on the magnitudes of shift ΔSα and ΔSβ in the following manner.

Meanwhile, the average of the grayscale levels r1 and r2 is calculated by another adding section 310r and that of the grayscale levels g1 and g2 is calculated by still another adding section 310g. In the following description, the average of the grayscale levels r1 and r2 will be referred to herein as an average grayscale level rₐᵥₑ and that of the grayscale levels g1 and g2 will be referred to herein as an average grayscale level gₐᵥₑ.

The saturation determining section 340 determines the saturation of the pixel represented by the input signal. Specifically, the saturation determining section 340 determines a saturation coefficient HW by using average grayscale levels rₐᵥₑ, gₐᵥₑ and bₐᵥₑ. The saturation coefficient HW is a function that decreases as the saturation increases. In the following description, if MAX=MAX (rₐᵥₑ, gₐᵥₑ, bₐᵥₑ) and MIN=MIN (rₐᵥₑ, gₐᵥₑ, bₐᵥₑ), then the saturation coefficient HW may be represented as HW=MIN/MAX, for example. However, if bₐᵥₑ=0, then the saturation coefficient HW is zero. Alternatively, with attention paid to only the saturation of the color blue, if bₐᵥₑ≧rₐᵥₑ, bₐᵥₑ≧gₐᵥₑ and bₐᵥₑ>0, then HTN=MIN/MAX. On the other hand, if at least one of bₐᵥₑ<rₐᵥₑ and bₐᵥₑ<gₐᵥₑ is satisfied, then HW=1.

Next, the magnitudes of shift ΔSα and ΔSβ are calculated. In this case, the magnitude of shift ΔSα is obtained as the product of ΔY_{b}α and the saturation coefficient HW, while the magnitude of shift ΔSβ is obtained as the product of ΔY_{b}β and the saturation coefficient HW. A multiplying section 350 multiplies the luminance level differences ΔY_{b}α and ΔY_{b}β by the saturation coefficient HW, thereby obtaining the magnitudes of shift ΔSα and ΔSβ.

Meanwhile, a grayscale-to-luminance converting section 360a carries out a grayscale-to-luminance conversion on the grayscale level b1, thereby obtaining a luminance level Y_{b1}, which can be calculated by the following equation:

Y_{b1}=b1^{2.2} (where 0≦b1≦1)

In the same way, another grayscale-to-luminance converting section 360b carries out a grayscale-to-luminance conversion on the grayscale level b2, thereby obtaining a luminance level Y_{b2}.

Next, an adding and subtracting section 370a adds the luminance level Y_{b1} and the magnitude of shift ΔSα together, and then the sum is subjected to luminance-to-grayscale conversion by a luminance-to-grayscale converting section 380a, thereby obtaining a corrected grayscale level b1′. On the other hand, another adding and subtracting section 370b subtracts the magnitude of shift ΔSβ from the luminance level Y_{b2}, and then the remainder is subjected to luminance-to-grayscale conversion by another luminance-to-grayscale converting section 380b, thereby obtaining a corrected grayscale level b2′. Thereafter, those corrected grayscale levels are input to the LCD panel 200.

As the grayscale level difference calculating section 320 gives the grayscale level differences Δbα and Δbβ, the grayscale level b1′ is given by b1+Δb1 and the grayscale level b2′ is given by b2−Δb2. As described above, using the grayscale levels b1′ and b2′, the blue subpixel B1 comes to have a luminance corresponding to the sum of the luminance level Y_{b1} and the magnitude of shift ΔSα and the blue subpixel B2 comes to have a luminance corresponding to the difference between the luminance level Y_{b2} and the magnitude of shift ΔSβ.

In this example, the grayscale levels b1 and b2 represented by the input signal are supposed to be grayscale level 0.5 and the grayscale levels r1, r2, g1 and g2 represented by the input signal are also supposed to be grayscale level 0.5. In that case, as a result of the grayscale to luminance conversion performed by the grayscale-to-luminance converting sections 360a and 360b, the luminance levels Y_{b1} and Y_{b2} will be 0.218 (=0.5^{2.2}). Also, as ΔY_{b}α and ΔY_{b}β are 0.133 (=0.4^{2.2}) and the saturation coefficient HW is one in this example, the magnitudes of shift ΔSα and ΔSβ are 0.133. In this case, if the highest grayscale level is supposed to be 255, the grayscale level b1′ obtained by the luminance-to-grayscale converting section 380a becomes grayscale level 158 (=(0.218+0.133)^{1/2.2}×255), while the grayscale level b2′ obtained by the luminance-to-grayscale converting section 380b becomes grayscale level 82 (=(0.218−0.133)^{1/2.2}×255). As described above, on the LCD panel 200 of the liquid crystal display device 100, each blue subpixel has two regions that can have mutually different luminances, the average of the luminances of the bright and dark regions of a bright blue subpixel becomes a luminance corresponding to the grayscale level 158. On the other hand, the average of the luminances of the bright and dark regions of a dark blue subpixel becomes a luminance corresponding to the grayscale level 82. Consequently, if the results obtained by performing addition and subtraction on the luminance level differences ΔY_{b}α and ΔY_{b}β that are equal to each other and on the magnitudes of shift ΔSα and ΔSβ that are also equal to each other are converted into grayscale levels and compared to the original ones before being subjected to the correction, then Δb1==30 (=158−128) and Δb2=46 (=128−82). In this manner, Δb1 and Δb2 are not the same value.

Also, in the correcting section 300, each of the magnitudes of shift ΔSα and ΔSβ is represented as a function that includes the saturation coefficient HW as a parameter. For example, if the highest grayscale level is supposed to be 255 and if (rₐᵥₑ, gₐᵥₑ, bₐᵥₑ)=(128, 128, 128), the saturation coefficient HW becomes one, and the magnitudes of shift ΔSα and ΔSβ become 0.133. On the other hand, if (rₐᵥₑ, gₐᵥₑ, bₐᵥₑ)=(0, 0, 128) (i.e., if there is any subpixel in OFF state), the saturation coefficient HW becomes zero, and the magnitudes of shift ΔSα and ΔSβ become zero, too. Furthermore, if (rₐᵥₑ, gₐᵥₑ, bₐᵥₑ)=(64, 64, 128) (i.e., if rₐᵥₑ and gₐᵥₑ are in the middle between these two situations), then HW=0.5 and the magnitudes of shift ΔSα and ΔSβ become 0.133×0.5 (i.e., a half value compared to the situation where HW is 1.0). In this manner, the blue subpixels belonging to the pixels designated by the input signal are subjected to the correction according to the saturation of the pixels specified by the input signal. Also, the magnitudes of shift ΔSα and ΔSβ change continuously according to the saturation of the pixels designated by the input signal, and therefore, a sudden change of the display performance can be minimized. It should be noted that if the saturation coefficient HW is zero (e.g., when a color blue with a high saturation is designated by the input signal), then the grayscale level b1 (=b2) represented by the input signal becomes equal to the grayscale levels b1′ and b2′. In this manner, by using the saturation coefficient HW, if there is any OFF-state subpixel, the grayscale level output will be the same as the grayscale level of blue subpixels as indicated by the input signal, and therefore, the resolution of the color blue does not decrease. On the other hand, if the grayscale levels of the respective subpixels indicated by the input signal are substantially equal to each other, then the resolution of the color blue does decrease, strictly speaking. However, such a decrease in the resolution of the color blue when an achromatic color or in a nearly achromatic color is displayed is actually not so noticeable considering the human visual sense. Furthermore, since the saturation coefficient HW is a function that changes continuously between a situation where there is an OFF-state subpixel and a situation where an achromatic color needs to be displayed, a sudden change on the display can be minimized.

In the foregoing description, unless the luminances of blue subpixels are adjusted, the grayscale level corresponding to an inflection point of the chromaticity x is supposed to be substantially equal to the grayscale level corresponding to an inflection point of the chromaticity y. However, this is just an example of the present invention. Rather, if the luminances of blue subpixels are not adjusted according to the material, structure, manufacturing process or method of adjustment of the LCD panel, the grayscale level corresponding to the inflection point of the chromaticity x does not have to be substantially equal to the grayscale level corresponding to the inflection point of the chromaticity y.

Furthermore, in the foregoing description, the luminances of blue subpixels are supposed to be adjusted over the entire range that is defined by the grayscale levels corresponding to the two inflection points so that the chromaticity when the LCD panel 200 is viewed obliquely changes substantially linearly between the two adjacent inflection points. However, this is only an example of the present invention. For example, if the chromaticity when the LCD panel 200 is viewed obliquely changes substantially linearly between the two adjacent inflection points, an achromatic color may appear to have a tint of another color (e.g., magenta) even though the yellow or blue shift has been reduced successfully. In that case, the luminances of blue subpixels do not have to be adjusted in some part of the range defined by the grayscale levels corresponding to the two inflection points but may be adjusted in the rest of that range.

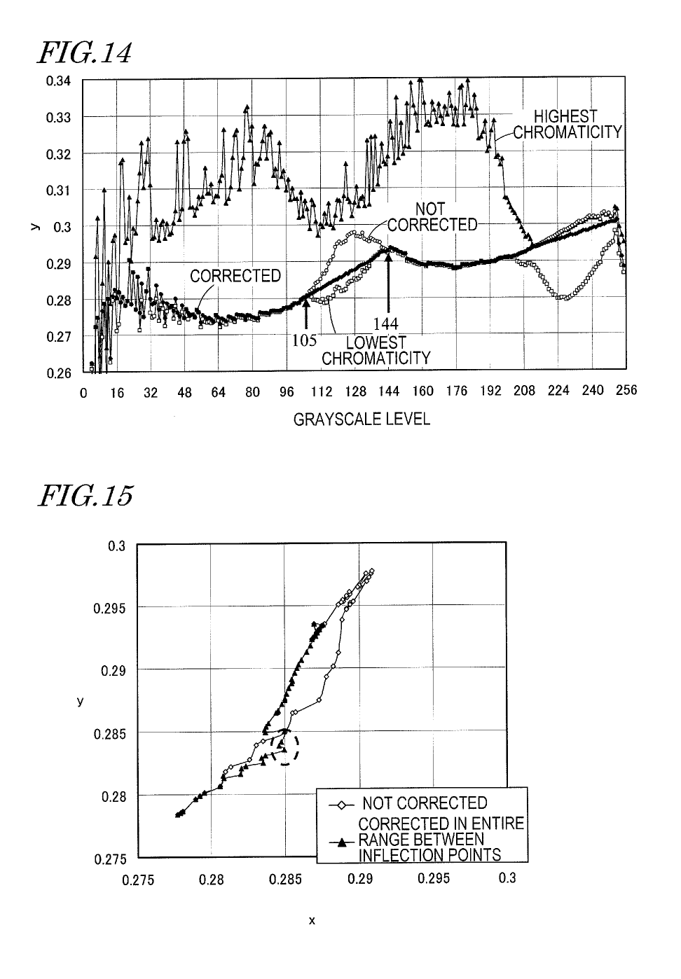

FIG. 14 shows how the chromaticity y changes on the LCD panel 200. In FIG. 14, with respect to each grayscale level, the highest chromaticity in the adjustable range is labeled as the “highest chromaticity” and the lowest value in the adjustable range is labeled as the “lowest chromaticity”. In FIG. 14, it is also shown for your reference how the chromaticity when viewed obliquely varies if no correction is made by the correcting section 300. As already described, the chromaticity y when viewed straight on is lower than any arbitrary chromaticity in the adjustable range when viewed obliquely. In the LCD panel 200 shown in FIG. 14, the chromaticity adjustable range varies according to the grayscale level more significantly than in the LCD panel shown in FIGS. 11 and 12. Also, depending on the material, structure, manufacturing process or method of adjustment of the LCD panel, the adjustable range may vary differently.

Specifically, if no correction is made by the correcting section 300 in the range from the grayscale level 0 through the level 104, the chromaticity when the LCD panel 200 is viewed obliquely becomes substantially equal to the lowest one in the adjustable range. Likewise, if no correction is made by the correcting section 300 in the range from the grayscale level 145 through the level 199 and in the range from the grayscale level 251 through the level 255, the chromaticity when the LCD panel 200 is viewed obliquely becomes substantially equal to the lowest one in the adjustable range. That is why by getting no correction made by the correcting section 300 when the grayscale level represented by the input signal falls within the range from the grayscale level 0 through the level 104, the range from the grayscale level 145 through the level 199 or the range from the grayscale level 251 through the level 255, the chromaticity when the LCD panel 200 is viewed obliquely can be substantially equal to the lowest one in the adjustable range.

On the other hand, if no correction is made on the luminances of blue subpixels by the correcting section 300 in the range from the grayscale level 105 through the level 144 and in the range from the grayscale level 200 through the level 250, the chromaticity when the LCD panel 200 is viewed obliquely becomes quite different from the lowest one in the adjustable range. In that case, if the LCD panel 200 is viewed obliquely, a yellow shift will be observed. Thus, the luminances of blue subpixels are adjusted in the range from the grayscale level 105 through the level 144 and in the range from the grayscale level 200 through the level 250 so that the chromaticity when the LCD panel 200 is viewed obliquely changes substantially linearly between the two adjacent inflection points of the lowest chromaticity curve. If such a correction is made, however, an achromatic color may sometimes appear to have a tint of another color.

FIG. 15 is an xy chromaticity diagram. In FIG. 15, the curve labeled as “not corrected” represents how the chromaticity when the LCD panel 200 was viewed obliquely varied if the luminances of blue subpixels were not adjusted in the entire range from the grayscale level 105 through the level 144. On the other hand, the curve labeled as “corrected in entire range between inflection points” represents how the chromaticity when the LCD panel 200 was viewed obliquely varied if the luminances of blue subpixels were adjusted in the entire range from the grayscale level 105 through the level 144.

If the luminances of blue subpixels are not adjusted, the chromaticities x and y both increase significantly as the grayscale level increases from the grayscale level 105 to the level 130 in that range defined by the grayscale levels corresponding to the two inflection points. As a result, an achromatic color may sometimes look yellowish. On the other hand, if the luminances of blue subpixels are adjusted so that the chromaticity when the LCD panel 200 is viewed obliquely changes substantially linearly between the two inflection points, then the achromatic color may appear to have a tint of the color magenta in the encircled range shown in FIG. 15. Specifically, if the luminances of blue subpixels are adjusted in the entire range from the grayscale level 105 through the level 144, the chromaticity y increases as the grayscale level rises. Meanwhile, the chromaticity x increases until the grayscale level rising from the level 105 reaches the level 120, once decreases around the grayscale level 120, and then increases again after that. In this manner, if the luminances of blue subpixels are adjusted in the entire range between the grayscale levels 105 and 144 that correspond to the two inflection points, the variation ratio of the chromaticity x to the chromaticity y changes significantly as the grayscale level rises. As a result, the achromatic color may sometimes appear to have a tint of the color magenta.

If the achromatic color appears to have shifted in this manner, the correcting section 300 shown in FIG. 1 does not adjust the luminances of blue subpixels in the entire range that is defined by the grayscale levels corresponding to the two inflection points. Instead, the correcting section 300 does not adjust the luminances of the blue subpixels in some part of that range defined by the grayscale levels corresponding to the two inflection points but does adjust the luminances of those blue subpixels in the rest of that range. Specifically, at grayscale levels at which the achromatic color shifts toward the color magenta (e.g., from the grayscale level 105, which is one of the two grayscale levels, through the level 115 in this example), the luminances of blue subpixels are not adjusted. On the other hand, in the range from the grayscale level 116 through the level 144, which corresponds to the other inflection point, where the achromatic color stops shifting toward the color magenta, the luminances of blue subpixels are adjusted so that the chromaticity when the LCD panel 200 is viewed obliquely changes substantially linearly.

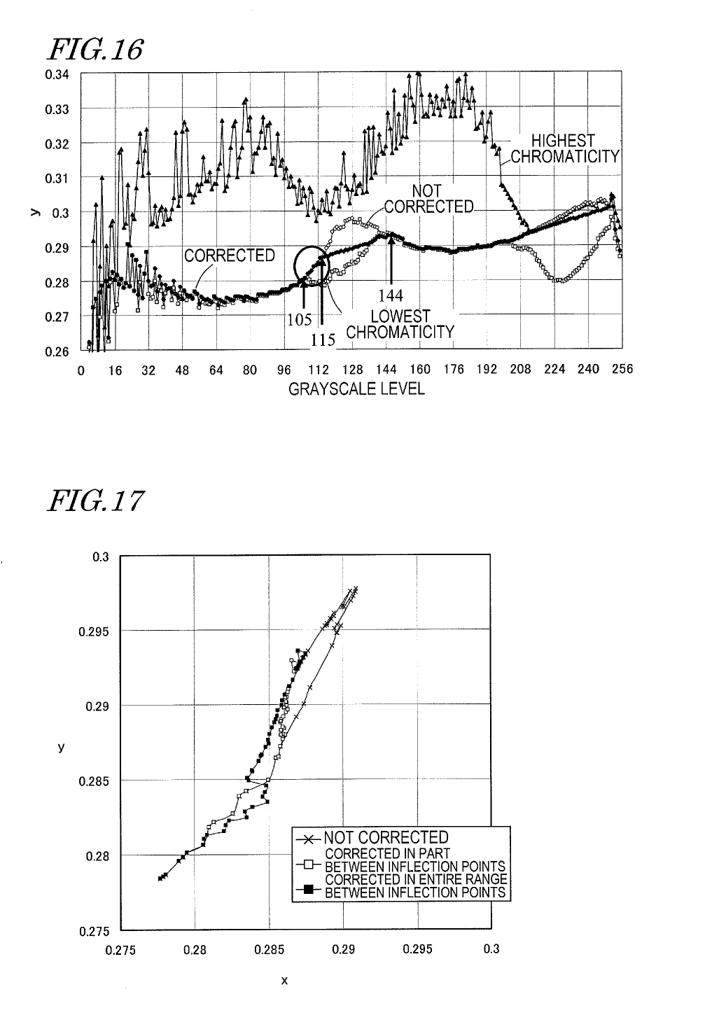

FIG. 16 shows how the chromaticity y changes on the LCD panel 200. In FIG. 16, with respect to each grayscale level, the highest chromaticity in the adjustable range is also labeled as the “highest chromaticity” and the lowest value in the adjustable range is also labeled as the “lowest chromaticity”. The encircled range shown in FIG. 16 indicates a range where the achromatic color appeared to have a tint of the color magenta when the luminances of blue subpixels were adjusted in the entire range defined by the two grayscale levels corresponding to the two inflection points as described above.

As described above, in this LCD panel 200, if no correction is made by the correcting section 300 in the range from the grayscale level 0 through the level 104, the chromaticity when the LCD panel 200 is viewed obliquely becomes substantially equal to the lowest one in the adjustable range. Likewise, if no correction is made by the correcting section 300 in the range from the grayscale level 145 through the level 199 and in the range from the grayscale level 251 through the level 255, the chromaticity when the LCD panel 200 is viewed obliquely becomes substantially equal to the lowest one in the adjustable range. That is why by getting no correction made by the correcting section 300 when the grayscale level represented by the input signal falls within the range from the grayscale level 0 through the level 104, the range from the grayscale level 145 through the level 199 or the range from the grayscale level 251 through the level 255, the chromaticity when the LCD panel 200 is viewed obliquely can be substantially equal to the lowest one in the adjustable range.

On the other hand, by getting no correction on the luminances of blue subpixels made by the correcting section 300 in the range from the grayscale level 105 through the level 115, the shift of the achromatic color can be reduced significantly. Meanwhile, unless the luminances of blue subpixels are adjusted by the correcting section 300 in the range from the grayscale level 116 through the level 144 and in the range from the grayscale level 200 through the level 250, the chromaticity when the LCD panel 200 is viewed obliquely will be quite different from the lowest chromaticity in the adjustable range. As a result, when the LCD panel 200 is viewed obliquely, a yellow shift will be observed. That is why the luminances of the blue subpixels are adjusted in the range from the grayscale level 116 through the level 144 so that the chromaticity y when the LCD panel 200 is viewed obliquely changes substantially linearly between the two chromaticities corresponding to the grayscale levels 116 and 144. Likewise, the luminances of the blue subpixels are adjusted in the range from the grayscale level 200 through the level 250 so that the chromaticity y when the LCD panel 200 is viewed obliquely changes substantially linearly between the two inflection points.

FIG. 17 is an xy chromaticity diagram. In FIG. 17, the curve labeled as “corrected in entire range between inflection points” represents how the chromaticity varied on the LCD panel 200 if the luminances of blue subpixels were adjusted in the entire range from the grayscale level 105 through the level 144. On the other hand, the curve labeled as “corrected in part between inflection points” represents how the chromaticity varied on the LCD panel 200 if the luminances of blue subpixels were not adjusted in the range from the grayscale level 105 through the level 115 but were adjusted in the range from the grayscale level 116 through the level 144. Also shown in FIG. 17 for your reference is how the chromaticity varied on the LCD panel 200 if the luminances of blue subpixels were not adjusted at all from the grayscale level 105 through the level 144.

If the luminances of blue subpixels are adjusted in the entire range between the two inflection points, the variation ratio of the chromaticity x to the chromaticity y changes significantly as the grayscale level rises. On the other hand, if the luminances of blue subpixels are adjusted in just a part of the range between the two inflection points, the variation ratio of the chromaticity x to the chromaticity y hardly changes. That is why the chromaticities x and y change more gently as a whole as the grayscale level rises. As a result, the shift of the achromatic color can be reduced significantly. In this manner, by getting no correction made at such grayscale levels at which the achromatic color shifts toward a different color but getting a correction made at such grayscale levels at which the achromatic color does not shift, the chromaticity when the LCD panel 200 is viewed obliquely changes more gently as a whole and the shift of the achromatic color toward another color can be suppressed.

As described above, in the LCD panel 200, each pixel has multiple regions. The grayscale level b1′ of a blue subpixel B1 is achieved by bright and dark regions and the grayscale level b2′ of a blue subpixel B2 is achieved by bright and dark regions. Also, if the multi-pixel drive technique is adopted, the distribution of the luminance levels Y_{b1} and Y_{b2} to the regions Ba and Bb of the blue subpixels B1 and B2 is determined by the structure and design values of the LCD panel 200, although not described in detail herein. As for specific design values, the average luminance of the regions Ba and Bb of the blue subpixel B1 agrees with the luminance corresponding to the grayscale level b1′ or b2′ of the blue subpixel. Although the multi-pixel drive technique is supposed to be adopted in the foregoing description, the multi-pixel drive technique does not always have to be adopted as long as luminance can be distributed to the regions Ba and Bb as intended by using the structure of the LCD panel 200 as described above.

In the example described above, the grayscale level b1 indicated by the input signal is equal to the grayscale level b2. However, the present invention is in no way limited to that specific preferred embodiment. Alternatively, the grayscale level b1 indicated by the input signal may be different from the grayscale level b2. Nevertheless, if the grayscale level b1 is different from the grayscale level b2, then the luminance level Y_{b1} that has been subjected to the grayscale-luminance conversion by the grayscale-to-luminance converting section 360a shown in FIG. 13 is different from the luminance level Y_{b2} that has been subjected to the grayscale-luminance conversion by the grayscale-to-luminance converting section 360b. If there is a great difference in grayscale level between adjacent pixels (particularly when a text is displayed), the difference between those luminance levels Y_{b1} and Y_{b2} is even more significant.

Specifically, if the grayscale level b1 is higher than the grayscale level b2, the luminance-to-grayscale converting sections 380a and 380b perform luminance-to-grayscale conversion based on the sum of the luminance level Y_{b1} and the magnitude of shift ΔSα and the difference between the luminance level Y_{b2} and the magnitude of shift ΔSβ, respectively. In that case, as shown in FIG. 18, the luminance level Y_{b1}′ corresponding to the grayscale level b1′ will be higher by the magnitude of shift ΔSα than the luminance level Y_{b1} corresponding to the grayscale level b1. The luminance level Y_{b2}′ corresponding to the grayscale level b2′ will be lower by the magnitude of shift ΔSβ than the luminance level Y_{b2} corresponding to the grayscale level b2. As a result, the difference between the respective luminances corresponding to the grayscale levels b1′ and b2′ will be bigger than the difference between the respective luminances corresponding to the grayscale levels b1 and b2.

Now take a look at four pixels P1 through P4, which are arranged in two columns and two rows and are located at upper left, upper right, lower left and lower right portions of the matrix. Also, the grayscale levels of respective blue subpixels as indicated by the input signal with respect to those pixels P1 through P4 will be identified herein by b1 through b4, respectively. As already described with reference to FIG. 4, if the input signal indicates that the respective subpixels should represent the same color (i.e., the grayscale levels b1 through b4 are equal to each other), the grayscale level b1′ is higher than the grayscale level b2′ and the grayscale level b4′ is higher than the grayscale level b3′.

Also, suppose the input signal indicates that the pixels P1 and P3 should have high grayscales and the pixels P2 and P4 should have low grayscales, there is a display boundary between the pixels P1 and P3 and between the pixels P2 and P4, the grayscale levels b1 and b2 satisfy b1>b2, and the grayscale levels b3 and b4 satisfy b3>b4. In that case, the difference between the respective luminances corresponding to the grayscale levels b1′ and b2′ will be bigger than the difference between the respective luminances corresponding to the grayscale levels b1 and b2. On the other hand, the difference between the respective luminances corresponding to the grayscale levels b3′ and b4′ will be smaller than the difference between the respective luminances corresponding to the grayscale levels b3 and b4.

Also, as described above, if the color indicated by the input signal is a single color (such as the color blue), then the saturation coefficient HW is either equal to, or close to, zero. In that case, the magnitude of shift decreases, the input signal is output as it is, and therefore, the resolution can be maintained. On the other hand, if the color indicated by the input signal is an achromatic color, then the saturation coefficient HW is either equal to, or close to, one. In that case, the luminance difference in a corrected image will increase and decrease from one column of pixels to another compared to the original image, thus making the edges look uneven and causing a decrease in resolution. Furthermore, if the grayscale levels b1 and b2 are either equal to, or close to, each other, such unevenness is not so noticeable considering the human visual sense. However, the bigger the difference between the grayscale levels b1 and b2, the more noticeable such unevenness gets.

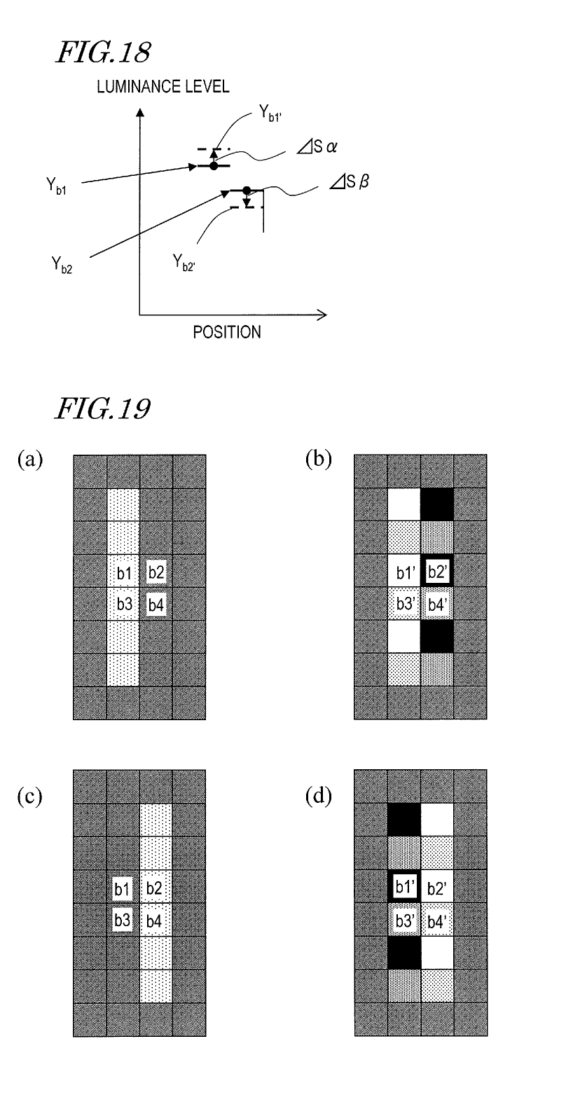

Hereinafter, a specific example will be described with reference to FIG. 19. In this example, the input signal is supposed to indicate that a line in an achromatic color with a relatively high luminance (i.e., a light gray line) should be displayed with a line width of one pixel on the background in an achromatic color with a relatively low luminance (i.e., a dark gray background). In that case, ideally, the viewer should sense that light gray line.

FIG. 19(a) shows the luminances of blue subpixels, of which the grayscale levels are not corrected by the correcting section 300, in the LCD panel 200. In this example, as for the grayscale levels b1 through b4 of the blue subpixels as indicated by the input signal with respect to the four pixels P1 through P4, the grayscale levels b1 and b2 satisfy b1>b2 and the grayscale levels b3 and b4 satisfy b3>b4. In that case, in the LCD panel 200, the blue subpixels of those four pixels P1 through P4 have luminances corresponding to the grayscale levels b1 through b4 indicated by the input signal.

FIG. 19(b) shows the luminances of blue subpixels, of which the grayscale levels have been corrected by the correcting section 300. In FIG. 19(b), the luminance of each blue subpixel shown is also the average of the respective luminances of its two regions. For example, the grayscale level b1′ of the blue subpixel of the pixel P1 is higher than the grayscale level b1, the grayscale level b2′ of the blue subpixel of the pixel P2 is lower than the grayscale level b2, the grayscale level b3′ of the blue subpixel of the pixel P3 is lower than the grayscale level b3, and the grayscale level b4′ of the blue subpixel of the pixel P4 is higher than the grayscale level b4. In this manner, in any two pixels that are adjacent to each other in either the row direction or the column direction, the grayscale level (luminance) alternately increases and decreases with respect to the one indicated by the input signal. That is why comparing FIGS. 19(a) and 19(b) to each other, it can be seen that as a result of the correction made by the correcting section 300 on the grayscale levels of the blue subpixels, the difference between the grayscale levels b1′ and b2′ becomes greater than the difference between the grayscale levels b1 and b2 as indicated by the input signal. On the other hand, the difference between the grayscale levels b3′ and b4′ becomes smaller than the difference between the grayscale levels b3 and b4 as indicated by the input signal. As a result, not only the column including the pixels P1 and P3 that are associated with the relatively high grayscale levels b1 and b3 in the input signal but also the pixel P4 that is associated with the relatively low grayscale level b4 in the input signal have blue subpixels with relatively high luminances. In that case, even if the input signal indicates that a light gray line should be represented in the image displayed, this liquid crystal display device 100 will display not only the light gray line but also blue dotted lines adjacent to that line. Consequently, the display quality decreases significantly in the contours of the gray line.

Meanwhile, if the grayscale levels b1 through b4 of the blue subpixels as indicated by the input signal satisfy b1<b2 and b3<b4 and unless the grayscale levels of the blue subpixels are corrected by the correcting section 300, the blue subpixels of those four pixels P1 through P4 in the LCD panel 200 will have luminances corresponding to the grayscale levels b1 through b4 indicated by the input signal as shown in FIG. 19(c). On the other hand, if the luminances of the blue subpixels are corrected by the correcting section 300, the blue subpixels of those four pixels P1 through P4 will have different luminances as shown in FIG. 19(d) from the situation where the luminances of the blue subpixels are not corrected by the correcting section 300.

Comparing FIGS. 19(c) and 19(d) to each other, it can be seen that as a result of the correction made by the correcting section 300 on the grayscale levels of the blue subpixels, the difference between the grayscale levels b1′ and b2′ becomes greater than the difference between the grayscale levels b1 and b2 as indicated by the input signal. On the other hand, the difference between the grayscale levels b3′ and b4′ becomes smaller than the difference between the grayscale levels b3 and b4 as indicated by the input signal. As a result, not only the column including the pixels P2 and P4 that are associated with the relatively high grayscale levels b2 and b4 in the input signal but also the pixel P3 that is associated with the relatively low grayscale level b3 in the input signal have blue subpixels with relatively high luminances. In that case, even if the input signal indicates that a light gray line should be represented in the image displayed, this liquid crystal display device 100 will display not only the light gray line but also blue dotted lines adjacent to that line. Consequently, the display quality decreases significantly in the contours of the gray line.

In the example described above, the magnitude of shift ΔSα is obtained as the product of the luminance level difference ΔY_{b}α and the saturation coefficient HW and the magnitude of shift ΔSβ is obtained as the product of the luminance level difference ΔY_{b}β and the saturation coefficient HW. To avoid that, however, a different parameter may be used in determining the magnitudes of shift ΔSα and ΔSβ. In general, when a text image is displayed, for example, the grayscale levels are significantly different between the blue subpixels included in adjacent pixels as indicated by the input signal in edges between a line of pixels that are displayed in the column direction and their adjacent pixels that are displayed in the background. That is why if the saturation coefficient HW is close to one, the difference in grayscale levels between the blue subpixels included in adjacent pixels may significantly change from one row to another and the image quality may decrease as a result of the correction. To avoid such a situation, a continuous coefficient representing the degree of color continuity between adjacent pixels as indicated by the input signal may also be used as an additional parameter to calculate the magnitudes of shift ΔSα and ΔSβ. If there is a relatively big difference between the grayscale levels b1 and b2, the magnitudes of shift ΔSα and ΔSβ may vary according to the continuous coefficient so as to be decreased either to zero or significantly. As a result, the decrease in image quality can be minimized. For example, if there is a relatively small difference between the grayscale levels b1 and b2, then the continuous coefficient increases and the luminances of blue subpixels belonging to adjacent pixels are controlled. However, if there is a relatively big difference between the grayscale levels b1 and b2 in the image boundary area, then the continuous coefficient may decrease and the luminances of the blue subpixels need not be controlled.

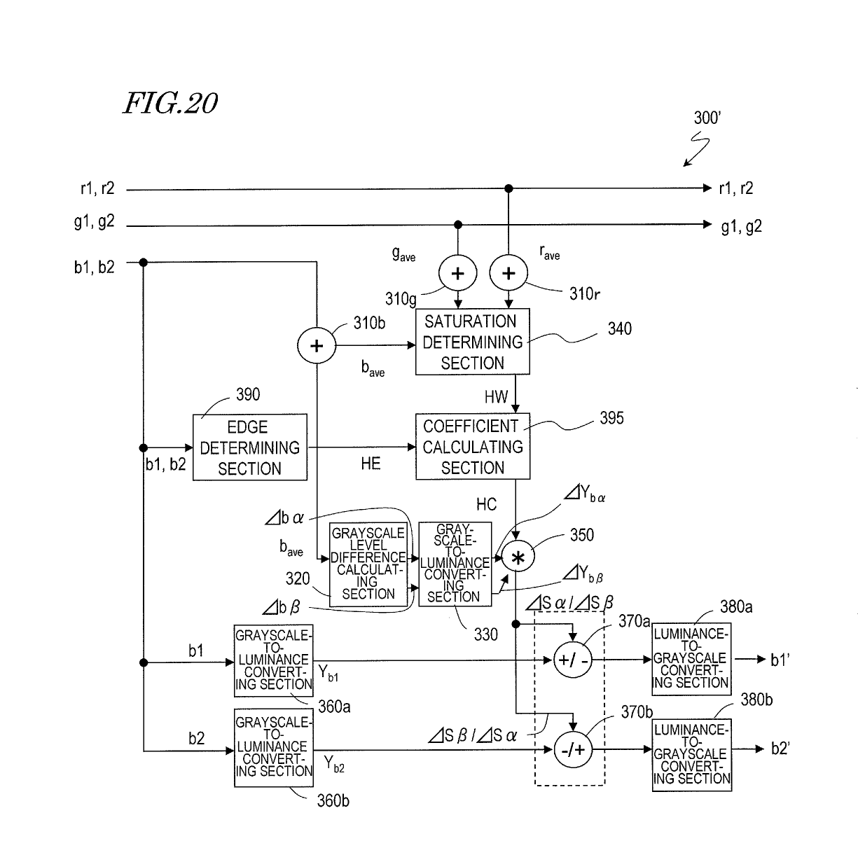

Hereinafter, a correcting section 300′ for controlling the luminances of blue subpixels as described above will be described with reference to FIG. 20. In the following example, edge coefficients are used in place of the continuous coefficients. This correcting section 300′ has the same configuration as the correcting section 300 that has already been described with reference to FIG. 13 except that this correcting section 300′ further includes an edge determining section 390 and a coefficient calculating section 395. And description of their common features will be omitted herein to avoid redundancies.

The edge determining section 390 obtains an edge coefficient HE based on the grayscale levels b1 and b2 that are indicated by the input signal. The edge coefficient HE is a function that increases as the difference in grayscale level between the blue subpixels of two adjacent pixels increases. If there is a relatively big difference between the grayscale levels b1 and b2 (i.e., if there is a low degree of continuity between the grayscale levels b1 and b2), then the edge coefficient HE is high. On the other hand, if there is a relatively small difference between the grayscale levels b1 and b2 (i.e., if there is a high degree of continuity between the grayscale levels b1 and b2), then the edge coefficient HE is low. In this manner, the lower the continuity in grayscale level between the blue subpixels of two adjacent pixels (i.e., the smaller the continuous coefficient described above), the higher the edge coefficient HE. And the higher the continuity in grayscale level between them (i.e., the greater the continuous coefficient described above), the lower the edge coefficient HE.

Also, the edge coefficient HE changes continuously according to the difference in grayscale level between the blue subpixels of two adjacent pixels. For example, if the absolute value of the difference in grayscale level between the blue subpixels of two adjacent pixels is |b1−b2| and if MAX=MAX (b1, b2), then the edge coefficient HE can be represented as HE=|b1−b2|/MAX. However, if MAX=0, then HE=0.

Next, the coefficient calculating section 395 calculates a correction coefficient HC based on the saturation coefficient HW that has been obtained by the saturation determining section 340 and the edge coefficient HE that has been obtained by the edge determining section 390. The correction coefficient HC may be represented as HC=HW−HE, for example. Optionally, clipping may be carried out so that the correction coefficient HC falls within the range of 0 to 1 in the coefficient calculating section 395. Subsequently, the multiplying section 350 multiplies the correction coefficient HC and the luminance level differences ΔY_{B}α and ΔY_{B}β together, thereby obtaining the magnitudes of shift ΔSα and ΔSβ.

In this manner, the correcting section 300′ obtains the magnitudes of shift ΔSα and ΔSβ by multiplying together the correction coefficient HC, which has been obtained based on the saturation coefficient HW and the edge coefficient HE, and the luminance level differences ΔY_{B}α and ΔY_{B}β. As described above, the edge coefficient HE is a function that increases as the difference in grayscale level between the blue subpixels of two adjacent pixels as indicated by the input signal increases. That is why the greater the edge coefficient HE, the smaller the correction coefficient HC that regulates the distribution of luminances and the less uneven the edges can get. As also described above, the saturation coefficient HW is a function that changes continuously and the edge coefficient HE is also a function that changes continuously according to the difference in grayscale level between the blue subpixels of two adjacent pixels. For that reason, the correction coefficient HC also changes continuously and a sudden change on the display can be minimized.

If the input signal indicates that adjacent pixels should represent an achromatic color with the same grayscale and that the grayscale levels b1 and b2 are equal to each other, then there is a big difference between the grayscale levels b1′ and b2′ that have been corrected by the correcting section 300′. As a result, the viewing angle characteristic can be improved. On the other hand, if the input signal indicates that adjacent pixels should represent achromatic colors with significantly different grayscales and that the grayscale levels b1 and b2 are quite different from each other, then the grayscale levels b1′ and b2′ are substantially equal to each other. In that case, the viewing angle characteristic can be improved less effectively but the “unevenness” can be eliminated from the edges because the LCD panel 200 displays the grayscale levels represented by the input signal as they are.

Suppose the input signal indicates that two pixels should represent an achromatic color. In that case, MAX (rₐᵥₑ, gₐᵥₑ, bₐᵥₑ)=MIN (rₐᵥₑ, gₐᵥₑ, bₐᵥₑ) and the saturation coefficient HW=1

If the input signal indicates that the achromatic colors represented by two pixels should have the same grayscale (e.g., when (r1, g1, b1)=(100, 100, 100) and (r2, g2, b2)=(100, 100, 100)), then MAX (rₐᵥₑ, gₐᵥₑ, bₐᵥₑ)=100, MIN (rₐᵥₑ, gₐᵥₑ, bₐᵥₑ)=100 and the saturation coefficient HW=1. In that case, the grayscale level b1 is equal to the grayscale level b2, the edge coefficient HE=0, and the correction coefficient HC=1. Consequently, the grayscale levels b1′ and b2′ are significantly different from the grayscale levels b1 and b2, respectively, and the luminances of the blue subpixels B1 and B2 on the LCD panel 200 are quite different from the luminances corresponding to the grayscale levels b1 and b2 as indicated by the input signal.

On the other hand, if the input signal indicates that the achromatic colors represented by two pixels should have different grayscales (e.g., when (r1, g1, b1)=(100, 100, 100) and (r2, g2, b2)=(50, 50, 50)), then MAX (rₐᵥₑ, gₐᵥₑ, bₐᵥₑ)=75, MIN (rₐᵥₑ, gₐᵥₑ, bₐᵥₑ)=75 and the saturation coefficient HW=1. In that case, the edge coefficient HE=0.5 (=|100−50|/100) and the correction coefficient HC=0.5. Consequently, the grayscale levels b1′ and b2′ are different from the grayscale levels b1 and b2, respectively, and the luminances of the blue subpixels B1 and B2 on the LCD panel 200 are different from the luminances corresponding to the grayscale levels b1 and b2 as indicated by the input signal.

Meanwhile, if the input signal indicates that the achromatic colors represented by two pixels should have rather different grayscales (e.g., when (r1, g1, b1)=(100, 100, 100) and (r2, g2, b2)=(0, 0, 0)), then MAX (rₐᵥₑ, gₐᵥₑ, bₐᵥₑ)=50, MIN (rₐᵥₑ, gₐᵥₑ, bₐᵥₑ)=50 and the saturation coefficient HW=1. In that case, the edge coefficient HE=1 (=|100−0|/100) and the correction coefficient HC=0. Consequently, if the correction coefficient is equal to zero, the grayscale levels b1′ and b2′ are equal to the grayscale levels b1 and b2, respectively, and the luminances of the blue subpixels B1 and B2 on the LCD panel 200 are substantially equal to the luminances corresponding to the grayscale levels b1 and b2 as indicated by the input signal.

In the foregoing description, a shift in the color yellow as viewed obliquely is supposed to be reduced. However, the color yellow is not the only color that appears to have shifted when viewed obliquely. In the following description, such a phenomenon that a color appears to have shifted will be referred to herein as a “color shift”. According to the present invention, various color shifts other than the shift in the color yellow can also be minimized.

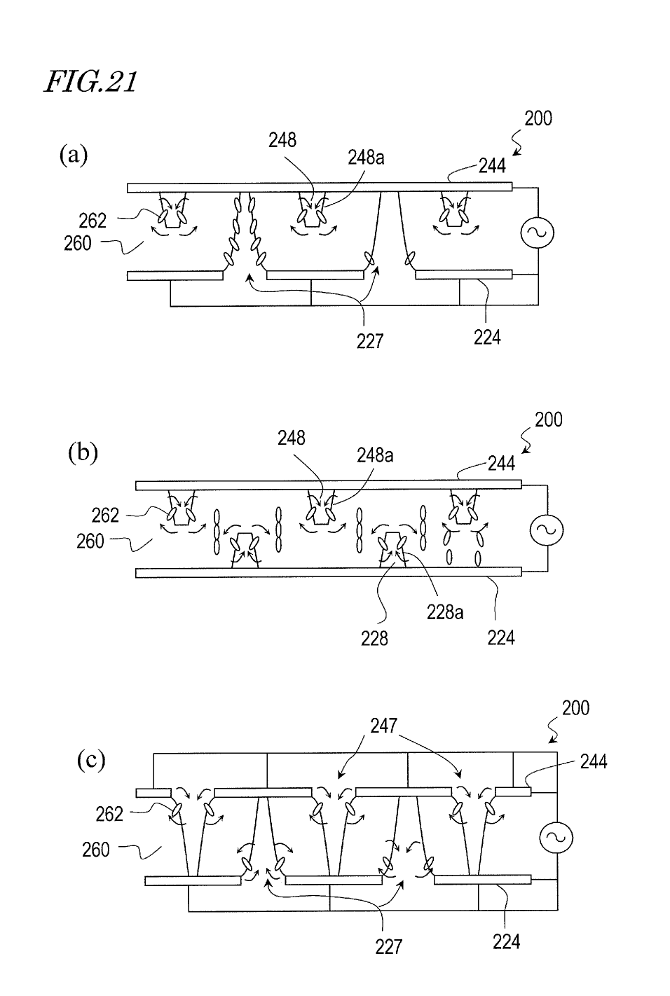

Also, as described above, the LCD panel 200 operates in the VA mode. Hereinafter, a specific exemplary configuration for the LCD panel 200 will be described. The LCD panel 200 may operate in the MVA mode. A configuration for such an MVA mode LCD panel 200 will be described with reference to FIGS. 21(a) to 21(c).

The LCD panel 200 includes pixel electrodes 224, a counter electrode 244 that faces the pixel electrodes 224, and a vertical alignment liquid crystal layer 260 that is interposed between the pixel electrodes 224 and the counter electrode 244. No alignment films are shown in FIG. 21.

Slits 227 or ribs 228 are arranged on the pixel electrodes 224 in contact with the liquid crystal layer 260. On the other hand, slits 247 or ribs 248 are arranged on the counter electrode 244 in contact with the liquid crystal layer 260. The former group of slits 227 or ribs 228 on the pixel electrodes 224 will be referred to herein as “first alignment control means”, while the latter group of slits 247 or ribs 248 on the counter electrode 244 as “second alignment control means”.

In each liquid crystal region defined between the first and second alignment control means, liquid crystal molecules 262 are given alignment control force by the first and second alignment control means and will fall (or tilt) in the direction indicated by the arrows in FIG. 21 when a voltage is applied to between the pixel electrodes 224 and the counter electrode 244. That is to say, since the liquid crystal molecules 262 fall in the same direction in each liquid crystal region, such a region can be regarded as a liquid crystal domain.

The first and second alignment control means (which will sometimes be collectively referred to herein as “alignment control means”) are arranged in stripes in each subpixel. FIGS. 21(a) to 21(c) are cross-sectional views as viewed on a plane that intersects at right angles with the direction in which those striped alignment control means runs. On two sides of each alignment control means, produced are two liquid crystal domains, in one of which liquid crystal molecules 262 fall in a particular direction and in the other of which liquid crystal molecules 262 fall in another direction that defines an angle of 180 degrees with respect to that particular direction. As the alignment control means, any of various alignment control means (domain regulating means) as disclosed in Japanese Patent Application Laid-Open Publication No. 11-242225 may be used, for example.

In FIG. 21(a), slits 227 (where there is no conductive film) are provided as the first alignment control means, and ribs (i.e., projections) 248 are provided as the second alignment control means. These slits 227 and ribs 248 are extended so as to run in stripes (or strips). When a potential difference is produced between one pixel electrode 224 and the counter electrode 244, each slit 227 generates an oblique electric field in a region of the liquid crystal layer 260 around the edges of the slit 227 and induces alignments of the liquid crystal molecules 262 perpendicularly to the direction in which the slit 227 runs. On the other hand, each rib 248 induces alignments of the liquid crystal molecules 262 substantially perpendicularly to its side surface 248a, and eventually, perpendicularly to the direction in which the rib 248 runs. Each slit 227 and its associated rib 248 are arranged parallel to each other with a certain interval left between them. That is to say, a liquid crystal domain is defined between one slit 227 and its associated rib 248 that are adjacent to each other.

Unlike the configuration shown in FIG. 21(a), one group of ribs 228 and another group of ribs 248 are provided as the first and second alignment control means, respectively, in the configuration shown in FIG. 21(b). Those two groups of ribs 228 and 248 are arranged parallel to each other with a certain gap left between them and induce alignments of the liquid crystal molecules 262 substantially perpendicularly to their side surfaces 228a and 248a, thereby producing liquid crystal domains between them.

Unlike the configurations shown in FIGS. 21(a) and 21(b), one group of slits 227 and another group of slits 247 are provided as the first and second alignment control means, respectively, in the configuration shown in FIG. 21(c). When a potential difference is produced between the pixel electrodes 224 and the counter electrode 244, those two groups of slits 227 and 247 generate an oblique electric field in a region of the liquid crystal layer 260 around their edges and induce alignments of the liquid crystal molecules 262 perpendicularly to the direction in which the slits 227 and 247 run. Those slits 227 and 247 are also arranged parallel to each other with a certain gap left between them, thereby producing liquid crystal domains between them.

As described above, such ribs and slits may be used in any arbitrary combination as the first and second alignment control means. For example, if the configuration shown in FIG. 21(a) is adopted for the LCD panel 200, then the increase in the number of manufacturing processing steps required can be minimized. Specifically, even if slits need to be cut through the pixel electrodes, no additional process steps have to be done. As for the counter electrode, on the other hand, the number of manufacturing processing steps increases less with the ribs provided than with the slits cut. However, it is naturally possible to adopt a configuration in which only ribs are used as the alignment control means or a configuration in which just slits are used as the alignment control means.

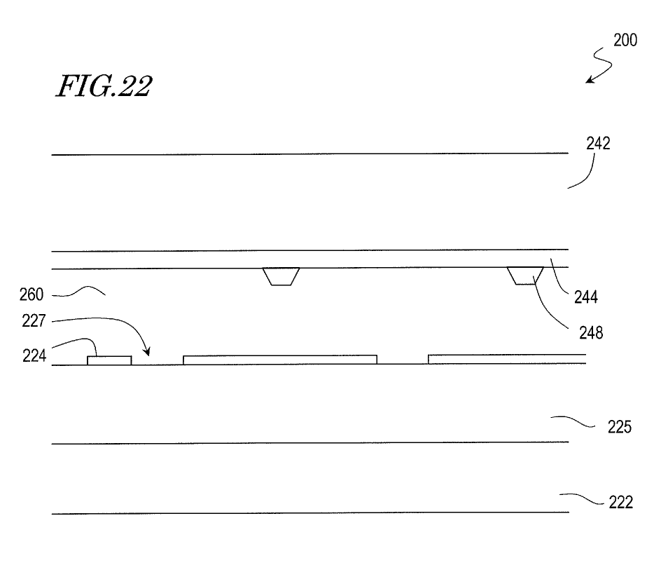

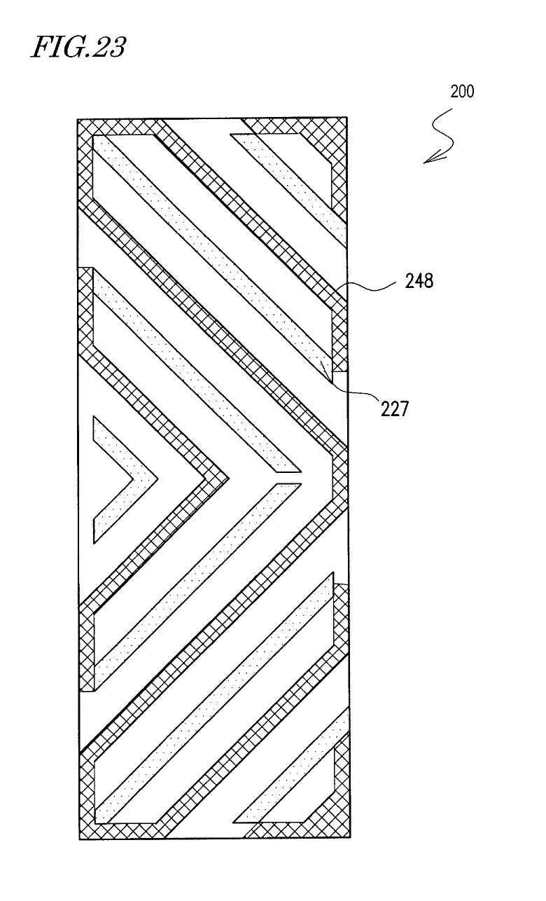

FIG. 22 is a partial cross-sectional view schematically illustrating a cross-sectional structure for the LCD panel 200. FIG. 23 is a plan view schematically illustrating a region allocated to one subpixel in the LCD panel 200. As shown in FIG. 23, the slits 227 have been cut so as to run in stripes and parallel to their adjacent ribs 248.

On the surface of an insulating substrate 222, arranged in contact with a liquid crystal layer 260 are gate bus lines (scan lines), source bus lines (signal lines) and TFTs (none of which are shown in FIG. 22), and an interlayer insulating film 225 is provided to cover all of those lines and TFTs. And pixel electrodes 224 have been formed on that interlayer insulating film 225. The pixel electrodes 224 and the counter electrode 244 face each other with the liquid crystal layer 260 interposed between them.

Striped slits 227 have been cut through the pixel electrodes 224. And almost the entire surface of the pixel electrodes 224, as well as inside the slits 227, is covered with a vertical alignment film (not shown). As shown in FIG. 23, those slits 227 run in stripes. Two adjacent slits 227 are arranged parallel to each other so that each slit 227 splits the gap between its adjacent ribs 248 into two substantially evenly.

In the region between a striped slit 227 and its associated rib 248, which are arranged parallel to each other, the alignment direction of liquid crystal molecules 262 is controlled by the slit 227 and the rib 248 that interpose that region. As a result, two domains are produced on both sides of the slit 227 and on both sides of the rib 248 so that the alignment direction of the liquid crystal molecules 262 in one of those two domains is different from that of the liquid crystal molecules 262 in the other domain by 180 degrees. In this LCD panel 200, the slits 227 are arranged to run in two different directions that define an angle of 90 degrees between them, so are the ribs 248 as shown in FIG. 23. Consequently, four liquid crystal domains, in any of which the alignment direction of the liquid crystal molecules 262 is different by 90 degrees from their counterparts' in each of its adjacent domains, are produced in each subpixel.

Also, the insulating substrates 222 and 242 and two polarizers (not shown) to put on the outside of those substrates 222 and 242 are arranged as crossed Nicols so that their transmission axes cross each other substantially at right angles. If the polarizers are arranged so that the alignment direction in each of the four domains, which is different by 90 degrees from the one in any adjacent domain, and the transmission axis of its associated one of the polarizers define an angle of 45 degrees between them, the variation in retardation due to the creation of those domains can be used most efficiently. For that reason, the polarizers are preferably arranged so that their transmission axes define an angle of substantially 45 degrees with respect to the directions in which the slits 227 and the ribs 248 run. Also, in a display device such as a TV to which the viewer often changes his or her viewing direction horizontally, the transmission axis of one of the two polarizers is preferably arranged horizontally with respect to the display screen in order to reduce the viewing angle dependence of the display quality. In the LCD panel 200 with such a configuration, when a predetermined voltage is applied to the liquid crystal layer 260, a number of regions (i.e., domains) where the liquid crystal molecules 262 tilt in mutually different directions are produced in each subpixel, thus realizing a display with a wide viewing angle.

In the preferred embodiment described above, the LCD panel 200 is supposed to operate in the MVA mode. However, this is just an example of the present invention. Alternatively, the LCD panel 200 may also operate in a CPA mode.

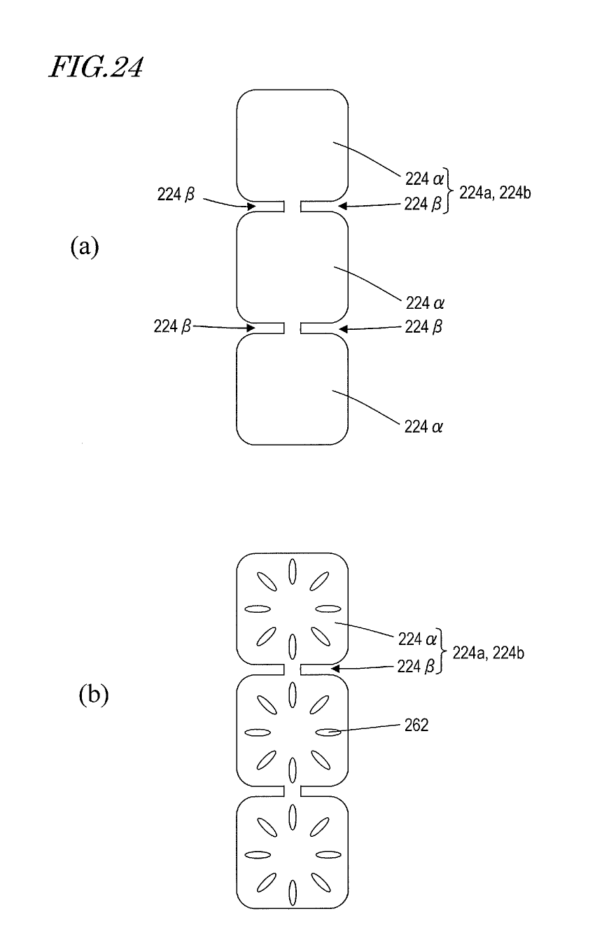

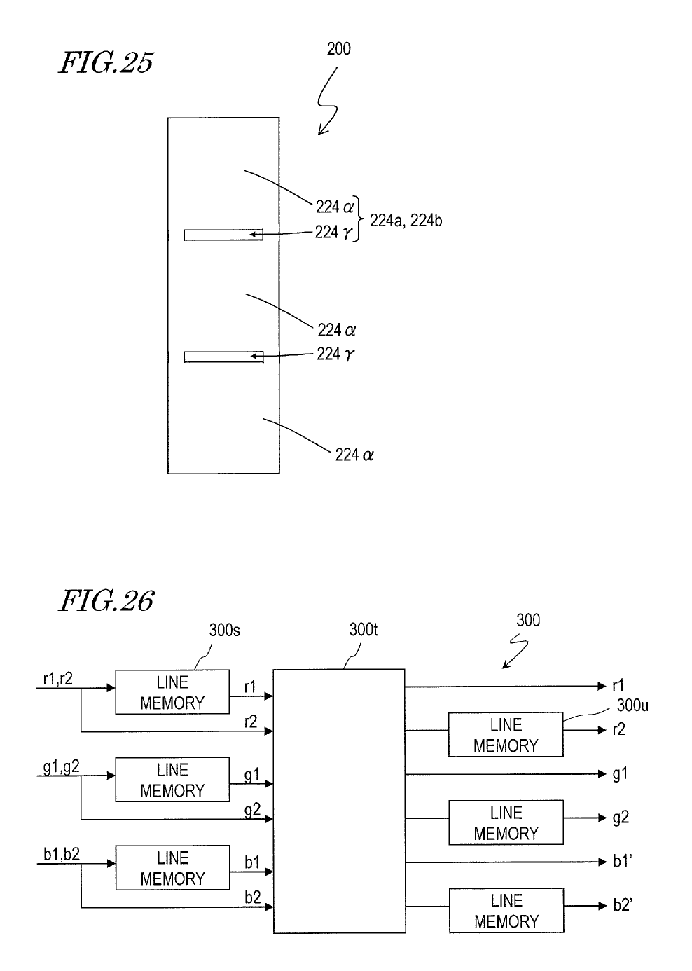

Hereinafter, a CPA mode LCD panel 200 will be described with reference to FIGS. 24 and 25. Each divided electrode 224a, 224b of the LCD panel 200 shown in FIG. 24(a) has multiple notches 224β at predetermined locations, which further divide the divided electrode 224a, 224b into a number of unit electrodes 224α. Each of those unit electrodes 224α has a substantially rectangular shape. In the example shown in FIG. 24, each divided electrode 224a, 224b is supposed to be subdivided into three unit electrodes 224α. However, the number of divisions does not have to be three.

When a voltage is applied to between the divided electrode 224a, 224b with such a configuration and the counter electrode (not shown), an oblique electric field is generated around the outer periphery of the divided electrode 224a, 224b and inside its notches 224β, thereby producing a number of liquid crystal domains in which liquid crystal molecules are aligned axisymmetrically (i.e., have radially tilted orientations) as shown in FIG. 24(b). One liquid crystal domain is produced on each unit electrode 224α. And in each liquid crystal domain, the liquid crystal molecules 262 tilt in almost every direction. That is to say, in this LCD panel 200, there are an infinite number of regions where the liquid crystal molecules 262 tilt in mutually different directions. As a result, a wide viewing angle display is realized.

The divided electrode 224a, 224b shown in FIG. 24 has notches 224β. Alternatively, the notches 224β may be replaced with openings 224γ as shown in FIG. 25. Each divided electrode 224a, 224b shown in FIG. 25 has multiple openings 224γ, which subdivide the divided electrode 224a, 224b into a number of unit electrodes 224α. When a voltage is applied to between such a divided electrode 224a, 224b and the counter electrode (not shown), an oblique electric field is generated around the outer periphery of the divided electrode 224a, 224b and inside its openings 224γ, thereby producing a number of liquid crystal domains in which liquid crystal molecules are aligned axisymmetrically (i.e., have radially tilted orientations).

In the examples illustrated in FIGS. 24 and 25, each single divided electrode 224a, 224b has either multiple notches 224β or multiple openings 224γ. However, if each divided electrode 224a, 224b needs to be split into two, only one notch 224β or opening 224γ may be provided. In other words, by providing at least one notch 224β or opening 224γ for each divided electrode 224a, 224b, multiple axisymmetrically aligned liquid crystal domains can be produced. The divided electrode 224a, 224b may have any of various shapes as disclosed in Japanese Patent Application Laid-Open Publication No. 2003-43525, for example.

In the preferred embodiments described above, the input signal is supposed to be a YCrCb signal, which is usually used as a color TV signal. However, the input signal does not have to be a YCrCb signal but may also indicate the luminances of respective subpixels representing either the three primary colors of R, G and B or any other set of three primary colors such as Ye, M and C (where Ye denotes yellow, M denotes magenta and C denotes cyan).

Also, although the correcting section 300 is supposed to include a saturation determining section 340 in the foregoing description, the present invention is in no way limited to that specific preferred embodiment. The correcting section 300 does not have to include the saturation determining section 340.

In the preferred embodiments described above, the luminances of blue subpixels are supposed to be controlled by using, as a unit, two blue subpixels belonging to two pixels that are arranged adjacent to each other in the row direction. However, the present invention is in no way limited to that specific preferred embodiment. Alternatively, the luminances of blue subpixels may also be controlled by using, as a unit, two blue subpixels belonging to two pixels that are arranged adjacent to each other in the column direction. Nevertheless, if those blue subpixels belonging to two adjacent pixels in the column direction are used as a unit, line memories and other circuit components are needed, thus increasing the circuit size required.

FIG. 26 is a schematic representation illustrating a correcting section 300 that is designed to control the luminances using, as a unit, two blue subpixels belonging to two pixels that are adjacent to each other in the column direction. As shown in FIG. 26, the correcting section 300 includes first-stage line memories 300s, a grayscale control section 300t, and second-stage line memories 300u. The grayscale levels r1, g1 and b1 are indicated by the input signal for red, green and blue subpixels belonging to one pixel. On the other hand, the grayscale levels r2, g2 and b2 are indicated by the input signal for red, green and blue subpixels belonging to another pixel that is adjacent to the former pixel in the column direction and located on the next row. The first-stage line memories 300s delay the input of the grayscale levels r1, g1, and b1 to the grayscale control section 300t by one line. The grayscale control section 300t has the same configuration as the correcting section that has already been described with reference to FIG. 13. The grayscale levels r1, r2, g1 and g2 are just passed through the grayscale control section 300t without being corrected. On the other hand, the grayscale levels b1 and b2 are corrected by the grayscale control section 300t into grayscale levels b1′ and b2′ as already described with reference to FIG. 4. Thereafter, the second-stage line memories 300u delay the grayscale levels r2, g2 and b2′ by one line. In this manner, the correcting section 300 controls the luminances using, as a unit, two blue subpixels belonging to two pixels that are adjacent to each other in the column direction.

On the liquid crystal display device, independent gamma correction processing may be carried out. Without the independent gamma correction processing, if the color indicated by the input signal changes from black to white while remaining achromatic colors, then the chromaticity of the achromatic color may vary uniquely to the LCD panel 200 when the LCD panel 200 is viewed straight on. By performing the independent gamma correction processing, however, such a chromaticity variation can be minimized. The correcting section 300 makes correction on the grayscale levels (or their corresponding luminance levels) of at least blue subpixels among those subpixels as indicated by the input signal at least under a predetermined condition.

In that case, the grayscale levels rgb indicated by the input signal go through the correcting section 300 and the independent gamma correction processing section and then are converted into luminance levels by the LCD panel 200. As a result, a voltage associated with the luminance level is applied to the liquid crystal layer 260 of the LCD panel 200 (see FIG. 2(a)).

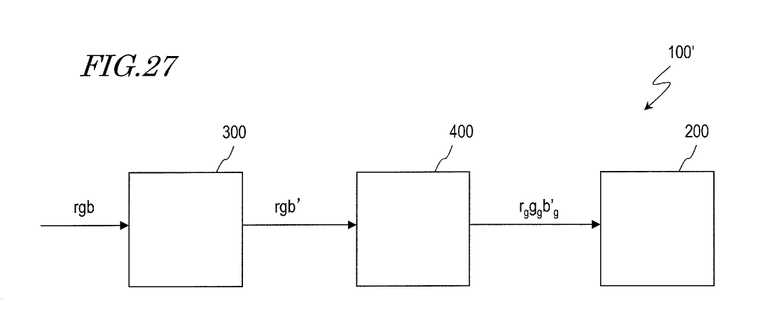

Hereinafter, the correcting section 300 and independent gamma correction processing section 400 of the liquid crystal display device 100′ will be described with reference to FIG. 27.

The grayscale levels rgb indicated by the input signal are corrected by the correcting section 300 at least under a certain condition. For example, the correcting section 300 may make no correction on the grayscale levels r and g indicated by the input signal but may correct the grayscale level b into a grayscale level b′. This correction will be described in detail later. The grayscale levels rgb′ that have been subjected to such correction by the correcting section 300 are then input to the independent gamma correction processing section 400.

The independent gamma correction processing section 400 includes red, green and blue processing sections for performing independent gamma correction processing on the respective grayscale levels r, g and b′. As a result of the independent gamma correction processing performed by these processing sections, the grayscale levels r, g and b′ are converted into grayscale levels r_{g}, g_{g} and b′_{g}.

As described above, by providing the independent gamma correction processing section 400, the variation in the chromaticity of an achromatic color according to the lightness can be reduced. With only the independent gamma correction processing section 400, the variation in the chromaticity of an achromatic color can be certainly reduced when the color represented by a pixel is viewed straight on, but the achromatic color may change its chromaticity and sometimes appear to have a tint of another color when viewed obliquely. For that reason, the correcting section 300 is provided for the liquid crystal display device 100′, thereby minimizing the variation in the chromaticity of the achromatic color when viewed obliquely.

In FIG. 27, the correcting section 300 is positioned before the independent gamma correction processing section 400. However, the present invention is in no way limited to that specific preferred embodiment. Alternatively, the independent gamma correction processing section 400 may also be positioned before the correcting section 300. In that case, the independent gamma correction processing section 400 makes independent gamma correction processing on the grayscale levels r, g and b indicated by the input signal, thereby obtaining grayscale levels r_{g}, g_{g} and b_{g}. After that, the correcting section 300 makes correction on the signal that has already been subjected to the independent gamma correction processing. As the multiplier for use to perform a luminance-to-grayscale conversion in the correcting section 300, not the fixed value (e.g., 2.2^{th} power) but a value that has been selected according to the characteristic of the LCD panel 200 is used.

Also, in the foregoing description, the grayscale level is supposed to be indicated by the input signal and the correcting section 300 is supposed to make a correction on the grayscale level of a blue subpixel. However, the present invention is in no way limited to that specific preferred embodiment. Alternatively, the input signal may indicate a luminance level instead, or the grayscale level may be converted into a luminance level, and then the correcting section 300 may make a correction on the luminance level of a blue subpixel. Nevertheless, since a luminance level is obtained by raising its corresponding grayscale level to the 2.2^{th} power, the precision of the luminance level should also be the 2.2^{th} power of that of the grayscale level. That is why a circuit for making a correction on grayscale levels can be implemented at a lower cost than a circuit for making a correction on luminance levels.

Furthermore, in the foregoing description, the saturation and the grayscale level difference are supposed to be determined based on an average grayscale level. However, this is just an example of the present invention. Alternatively, the saturation and the grayscale level difference may also be determined based on an average luminance level. Nevertheless, since a luminance level is obtained by raising its corresponding grayscale level to the 2.2^{th} power, the precision of the luminance level should also be the 2.2^{th} power of that of the grayscale level. That is why although a lookup table that stores luminance difference levels requires a big circuit size, a lookup table that stores grayscale level differences is implementable in a small circuit size.

### INDUSTRIAL APPLICABILITY

The present invention provides a liquid crystal display device that can minimize deterioration in display quality that could be caused when the screen is viewed obliquely.

### REFERENCE SIGNS LIST

100 liquid crystal display device
200 LCD panel
300 correcting section
400 independent gamma correction processing section

1. A method for fabricating a liquid crystal display device, the method comprising the steps of:
providing a liquid crystal display panel, which includes an active-matrix substrate, a counter substrate, and a vertical alignment liquid crystal layer that is interposed between the active-matrix substrate and the counter substrate and which has a number of pixels, each of the pixels including multiple subpixels that include red, green and blue subpixels, each of the subpixels having multiple regions, of which the luminances are able to be different from each other;
if an input signal indicates that two adjacent ones of the pixels should represent an achromatic color with the same grayscale level,
obtaining the chromaticity of the liquid crystal display panel when viewed straight on with respect to each said grayscale level and determining a range in which the chromaticity of the liquid crystal display panel when viewed obliquely is adjustable by changing the luminances of respective blue subpixels belonging to the two pixels within their adjustable range; and
setting the luminances of the blue subpixels so that the chromaticity of the liquid crystal display panel when viewed obliquely becomes as close to the chromaticity of the liquid crystal display panel when viewed straight on as possible within the adjustable range with respect to at least a part of the entire range of the grayscale levels.

2. The method for fabricating a liquid crystal display device of claim 1, wherein in the step of setting the luminances of the blue subpixels, the liquid crystal display panel has a lower chromaticity when viewed straight on than when viewed obliquely with respect to each said grayscale level.

3. The method for fabricating a liquid crystal display device of claim 2, wherein in the step of setting the luminances of the blue subpixels, if a lowest chromaticity curve, which is plotted by connecting together, over the entire range of the grayscale levels, the respective lowest chromaticities in the adjustable ranges that are associated with the respective grayscale levels, has multiple inflection points, the chromaticity of the liquid crystal display panel when viewed obliquely is different from the lowest chromaticity within the adjustable range at grayscale levels between two adjacent ones of the multiple inflection points.

4. The method for fabricating a liquid crystal display device of claim 3, wherein the step of setting the luminances of the blue subpixels includes setting the luminances of the blue subpixels so that the chromaticity of the liquid crystal display panel when viewed obliquely changes substantially linearly between the two inflection points.

5. The method for fabricating a liquid crystal display device of claim 4, wherein in the step of setting the luminances of the blue subpixels,
if the grayscale level is between the two inflection points, the luminance of the blue subpixel that is included in one of the two pixels of the liquid crystal display panel is set to be different from the luminance of the blue subpixel that is included in the other pixel, and
if the chromaticity of the liquid crystal display panel when viewed obliquely is the lowest one within the adjustable range, the luminance of the blue subpixel that is included in one of the two pixels of the liquid crystal display panel is set to be substantially equal to the luminance of the blue subpixel that is included in the other pixel.

6. The method for fabricating a liquid crystal display device of claim 3, wherein in the step of setting the luminances of the blue subpixels,
if the grayscale level is located at some point between the two inflection points, the luminance of the blue subpixel that is included in one of the two pixels of the liquid crystal display panel is set to be substantially equal to that of the blue subpixel that is included in the other pixel, and
if the grayscale level is located at another point between the two inflection points, the luminance of the blue subpixel that is included in one of the two pixels of the liquid crystal display panel is set to be different from the luminance of the blue subpixel that is included in the other pixel.
